(19) United States
(12) Patent Application Publication
(10) Pub. No.: US 2008/0236911 A1
(43) Pub. Date: Oct. 2, 2008

(54) Power output apparatus and method for controlling the same, and vehicle and drive system

(76) Inventors: Masaya Yamamoto, Kasugai-shi (JP); Yoichi Tajima, Anjo-shi (JP)

Correspondence Address: KENYON & KENYON LLP, 1500 K STREET N.W., SUITE 700, WASHINGTON, DC, 20005, US

(21) Appl. No.: 11/984,633

(22) Filed: Nov. 20, 2007

(30) Foreign Application Priority Data
Mar. 30, 2007 (JP) 2007-92305

(51) Int. Cl. B60K 6/36

(52) U.S. Cl. 180/65.2; 180/65.6; 477/3; 74/661; 903/902

(57) ABSTRACT

When the shift stage of a transmission is not being changed, a change gear ratio Gr of a transmission is calculated by setting an inputted rotation speed Nm2 as a control rotation speed Nm2*, and when the shift stage of the transmission is being changed, the change gear ratio Gr is calculated by setting the rotation speed that is obtained by adding a value obtained by multiplying a difference ΔNm2, which corresponds to the time differential component of the rotation speed Nm2, by a gain km to the rotation speed Nm2 (S130 to S160). By using these, torque commands Tm1* and Tm2* of motors MG1 and MG2 are set so that the engine is operated at an operation point represented by a target rotation speed Ne* and a target torque Te*, by which the engine and the motors MG1 and MG2 are controlled.

### BACKGROUND

1. Technical Field

The present invention relates to a power output apparatus and a method for controlling the apparatus, and a vehicle and a drive system.

2. Related Art

As a power output apparatus of this type, there has conventionally been proposed an on-board power output apparatus in which an engine, a first motor, and a drive shaft are connected to a planetary gear mechanism and a second motor is connected to a drive shaft via a transmission, characterized in that control is carried out by using the gear ratio of transmission obtained by dividing the rotation speed of the second motor by the rotation speed of the drive shaft (for example, refer to Japanese Patent Laid-Open No. 2006-298308). In this apparatus, when an abnormality occurs on a sensor for detecting the rotation speed of the drive shaft, the rotation speed of the drive shaft is calculated from the rotation speed of the internal combustion engine and the rotation speed of the first motor, and control is carried out by using the gear ratio of transmission obtained from the calculated rotation speed of the drive shaft and the rotation speed of the second motor, by which a shift of transmission can be accomplished even when the sensor is abnormal.

### SUMMARY

Generally, the rotation speed detected by the sensor may somewhat differ from the actual rotation speed because of sensing delay, calculation delay, communication delay, and the like. When the change in rotation speed is small, no problem arises. However, as in the case of the aforementioned power output apparatus, when the shift stage of the transmission is being changed, the rotation speed of the second motor changes suddenly, so that deviation of the actual rotation speed from the rotation speed obtained by the detection is induced. Such deviation disables appropriate torque control of the second motor when the shift stage of the transmission is changed while torque is delivered from the second motor to the drive shaft via the transmission. Therefore, unexpected high or low torque is delivered to the drive shaft.

The power output apparatus and the method for controlling the apparatus, and the vehicle and the drive system in accordance with the present invention have an object of delivering more appropriate torque from a motor when the change gear ratio of a transmission is changed while torque is delivered from a motor in the case where the motor for delivering power to a drive shaft via the transmission is provided. Also, the power output apparatus and the method for controlling the apparatus, and the vehicle and the drive system in accordance with the present invention have another object of restraining unexpected fluctuations in torque of drive shaft produced when the change gear ratio of the transmission is changed while torque is delivered from the motor in the case where the motor for delivering power to a drive shaft via the transmission is provided.

At least part of the above and the other related objects is attained by a power output apparatus and a method for controlling the apparatus, and a vehicle and a drive system of the invention having the configurations discussed below.

The present invention is directed to a power output apparatus for delivering power to a drive shaft. The power output apparatus includes: an internal combustion engine; an electric power-mechanical power input output mechanism which is connected to the drive shaft and also rotatably connected to an output shaft of the internal combustion engine independently of the drive shaft to input and output torque to and from the drive shaft and the output shaft along with the input and output of electric power and mechanical power; a motor capable of delivering mechanical power; a transmission mechanism which is connected to a rotating shaft of the motor and the drive shaft to accomplish gear shift of mechanical power along with the change of change gear ratio between the rotating shaft and the drive shaft; an accumulator unit capable of sending electric power to and from the electric power-mechanical power input output mechanism and the motor; a drive shaft rotation speed detecting mechanism for detecting a drive shaft rotation speed, which is the rotation speed of the drive shaft; a motor rotation speed detecting mechanism for detecting a motor rotation speed, which is the rotation speed of the motor; a predicted rotation speed calculating mechanism for calculating a predicted rotation speed, which is the rotation speed of the motor predicted at the control time, based on the detected motor rotation speed; a torque demand setting mechanism for setting a torque demand required by the drive shaft; a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and a control module which controls the internal combustion engine, the electric power-mechanical power input output mechanism, the motor, and the transmission mechanism so that the torque based on the set torque demand is delivered to the drive shaft by using the calculated control change gear ratio along with the change of the change gear ratio of the transmission mechanism.

In the power output apparatus in accordance with the present invention, the predicted rotation speed, which is the rotation speed of motor predicted at the time when the motor is controlled, is calculated based on the motor rotation speed, which is the rotation speed of the motor, and when the change gear ratio of the transmission mechanism is not being changed, the control change gear ratio, which is the control change gear ratio of the transmission mechanism, is calculated based on the drive shaft rotation speed, which is the rotation speed of the drive shaft, and the motor rotation speed, and when the change gear ratio of the transmission mechanism is being changed, the control change gear ratio is calculated based on the drive shaft rotation speed and the predicted rotation speed. Then, the internal combustion engine, the electric power-mechanical power input output mechanism, the motor, and the transmission mechanism are controlled so that the torque based on the torque demand required by the drive shaft is delivered to the drive shaft by using the control change gear ratio along with the change of the change gear ratio of the transmission mechanism. That is to say, when the change gear ratio of the transmission mechanism is not being changed, the internal combustion engine, the electric power-mechanical power input output mechanism, and the motor are controlled so that the torque based on the torque demand required by the drive shaft is delivered to the drive shaft by using the control change gear ratio calculated based on the drive shaft rotation speed and the motor rotation speed, which are detected values, and when the change gear ratio of the transmission mechanism is being changed, the internal combustion engine, the electric power-mechanical power input output mechanism, the motor, and the transmission mechanism are controlled so that the torque based on the torque demand required by the drive shaft is delivered to the drive shaft by using the control change gear ratio calculated based on the drive shaft rotation speed, which is a detected value, and the predicted rotation speed. Thus, when the change gear ratio of the transmission mechanism is being changed, the control is carried out by using the control change gear ratio calculated based on the predicted rotation speed. Therefore, the deviation of the predicted rotation speed from the actual rotation speed at the control time can be decreased as compared with the case where the motor rotation speed, which is a detected value, is used, so that the motor can be controlled more appropriately. As a result, unexpected fluctuations in torque of the drive shaft, which may be produced when the change gear ratio of the transmission mechanism is changed while torque is delivered from the motor, can be restricted.

In one preferable embodiment of the present invention, the control module is a module for controlling the motor so that the torque obtained based on a necessary torque obtained by subtracting a direct torque, which is delivered to the drive shaft via the electric power-mechanical power input output mechanism, from the set torque demand and the calculated control change gear ratio is delivered from the motor. In this case, the power output apparatus further includes an input and output limits setting mechanism for setting input and output limits, which are maximum allowable power that allows the charge and discharge of the accumulator unit, based on the state of accumulator unit, and for the motor, the control module is a module for controlling the motor so that the torque obtained by dividing the necessary torque by the control change gear ratio within the range of an input limit to an output limit is delivered from the motor. With this arrangement, the change gear ratio of the transmission mechanism can be changed while the charge and discharge of accumulator unit caused by excessive electric power exceeding the input and output limits of the accumulator unit are restrained.

In another preferable embodiment of the present invention, for the internal combustion engine and the electric power-mechanical power input output mechanism, the control module is a module for controlling the internal combustion engine and the electric power-mechanical power input output mechanism so that a target operation point at which the internal combustion engine should be operated is set based on the set torque demand and a predetermined restriction on the operation of the internal combustion engine and a target drive state of the electric power-mechanical power input output mechanism is set so that the internal combustion engine is operated at the set target operation point, and the internal combustion engine is operated at the set target operation point and also the electric power-mechanical power input output mechanism is driven in the set target drive state. Here, a “predetermined restriction” is a restriction that an operation point of internal combustion engine at which the highest efficiency can be achieved when the same power is delivered is selected, a restriction that an operation point of internal combustion engine at which the highest torque can be delivered when the same power is delivered is selected, and other restrictions can be cited.

In still another preferable embodiment of the present invention, the predicted rotation speed calculating mechanism is a mechanism for calculating the predicted rotation speed by adding a corrected rotation speed obtained by multiplying a value corresponding to the time differential component of the detected motor rotation speed by a predetermined gain to the detected motor rotation speed. With this arrangement, the predicted rotation speed can be calculated by simple calculation.

In still another preferable embodiment of the present invention, the transmission mechanism is a stepped transmission. Further, the electric power-mechanical power input output mechanism may be a mechanism having a generator for inputting and outputting power and a three shaft-type power input output module that is connected to the drive shaft, the output shaft, and the rotating shaft of the generator, and inputs and outputs power, based on the power inputted to and outputted from any two shafts of the three shafts, to and from the remaining shaft.

The present invention is also directed to a vehicle. The vehicle includes: an internal combustion engine; an electric power-mechanical power input output mechanism which is connected to a drive shaft connected to an axle and also rotatably connected to an output shaft of the internal combustion engine independently of the drive shaft to input and output torque to and from the drive shaft and the output shaft along with the input and output of electric power and mechanical power; a motor capable of delivering mechanical power; a transmission mechanism which is connected to a rotating shaft of the motor and the drive shaft to accomplish gear shift of mechanical power along with the change of change gear ratio between the rotating shaft and the drive shaft; an accumulator unit capable of sending electric power to and from the electric power-mechanical power input output mechanism and the motor; a drive shaft rotation speed detecting mechanism for detecting a drive shaft rotation speed, which is the rotation speed of the drive shaft; a motor rotation speed detecting mechanism for detecting a motor rotation speed, which is the rotation speed of the motor; a predicted rotation speed calculating mechanism for calculating a predicted rotation speed, which is the rotation speed of the motor predicted at the control time, based on the detected motor rotation speed; a torque demand setting mechanism for setting a torque demand required by the drive shaft; a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and a control module which controls the internal combustion engine, the electric power-mechanical power input output mechanism, the motor, and the transmission mechanism so that the torque based on the set torque demand is delivered to the drive shaft by using the calculated control change gear ratio along with the change of the change gear ratio of the transmission mechanism.

In the vehicle in accordance with the present invention, the predicted rotation speed, which is the rotation speed of motor predicted at the time when the motor is controlled, is calculated based on the motor rotation speed, which is the rotation speed of the motor, and when the change gear ratio of the transmission mechanism is not being changed, the control change gear ratio, which is the control change gear ratio of the transmission mechanism, is calculated based on the drive shaft rotation speed, which is the rotation speed of the drive shaft, and the motor rotation speed, and when the change gear ratio of the transmission mechanism is being changed, the control change gear ratio is calculated based on the drive shaft rotation speed and the predicted rotation speed. Then, the internal combustion engine, the electric power-mechanical power input output mechanism, the motor, and the transmission mechanism are controlled so that the torque based on the torque demand required by the drive shaft is delivered to the drive shaft by using the control change gear ratio along with the change of the change gear ratio of the transmission mechanism. That is to say, when the change gear ratio of the transmission mechanism is not being changed, the internal combustion engine, the electric power-mechanical power input output mechanism, and the motor are controlled so that the torque based on the torque demand required by the drive shaft is delivered to the drive shaft by using the control change gear ratio calculated based on the drive shaft rotation speed and the motor rotation speed, which are detected values, and when the change gear ratio of the transmission mechanism is being changed, the internal combustion engine, the electric power-mechanical power input output mechanism, the motor, and the transmission mechanism are controlled so that the torque based on the torque demand required by the drive shaft is delivered to the drive shaft by using the control change gear ratio calculated based on the drive shaft rotation speed, which is a detected value, and the predicted rotation speed. Thus, when the change gear ratio of the transmission mechanism is being changed, the control is carried out by using the control change gear ratio calculated based on the predicted rotation speed. Therefore, the deviation of the predicted rotation speed from the actual rotation speed at the control time can be decreased as compared with the case where the motor rotation speed, which is a detected value, is used, so that the motor can be controlled more appropriately. As a result, unexpected fluctuations in torque of the drive shaft, which may be produced when the change gear ratio of the transmission mechanism is changed while torque is delivered from the motor, can be restricted.

The present invention is also directed to a drive system incorporated in a power output apparatus for delivering power to a drive shaft together with an internal combustion engine and an accumulator unit. The drive system includes: an electric power-mechanical power input output mechanism which can send and receive electric power to and from the accumulator unit, and is connected to the drive shaft and also rotatably connected to an output shaft of the internal combustion engine independently of the drive shaft to input and output torque to and from the drive shaft and the output shaft along with the input and output of electric power and mechanical power; a motor which can send and receive electric power to and from the accumulator unit and can deliver mechanical power; a transmission mechanism which is connected to a rotating shaft of the motor and the drive shaft to accomplish gear shift of mechanical power along with the change of change gear ratio between the rotating shaft and the drive shaft; a drive shaft rotation speed detecting mechanism for detecting a drive shaft rotation speed, which is the rotation speed of the drive shaft; a motor rotation speed detecting mechanism for detecting a motor rotation speed, which is the rotation speed of the motor; a predicted rotation speed calculating mechanism for calculating a predicted rotation speed, which is the rotation speed of the motor predicted at the control time, based on the detected motor rotation speed; a torque demand setting mechanism for setting a torque demand required by the drive shaft; a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and a control module which controls the electric power-mechanical power input output mechanism, the motor, and the transmission mechanism in addition to the internal combustion engine so that the torque based on the set torque demand is delivered to the drive shaft by using the calculated control change gear ratio along with the change of the change gear ratio of the transmission mechanism.

In the drive system in accordance with the present invention, the predicted rotation speed, which is the rotation speed of motor predicted at the time when the motor is controlled, is calculated based on the motor rotation speed, which is the rotation speed of the motor, and when the change gear ratio of the transmission mechanism is not being changed, the control change gear ratio, which is the control change gear ratio of the transmission mechanism, is calculated based on the drive shaft rotation speed, which is the rotation speed of the drive shaft, and the motor rotation speed, and when the change gear ratio of the transmission mechanism is being changed, the control change gear ratio is calculated based on the drive shaft rotation speed and the predicted rotation speed. Then, the internal combustion engine, the electric power-mechanical power input output mechanism, the motor, and the transmission mechanism are controlled so that the torque based on the torque demand required by the drive shaft is delivered to the drive shaft by using the control change gear ratio along with the change of the change gear ratio of the transmission mechanism. That is to say, when the change gear ratio of the transmission mechanism is not being changed, the internal combustion engine, the electric power-mechanical power input output mechanism, and the motor are controlled so that the torque based on the torque demand required by the drive shaft is delivered to the drive shaft by using the control change gear ratio calculated based on the drive shaft rotation speed and the motor rotation speed, which are detected values, and when the change gear ratio of the transmission mechanism is being changed, the internal combustion engine, the electric power-mechanical power input output mechanism, the motor, and the transmission mechanism are controlled so that the torque based on the torque demand required by the drive shaft is delivered to the drive shaft by using the control change gear ratio calculated based on the drive shaft rotation speed, which is a detected value, and the predicted rotation speed. Thus, when the change gear ratio of the transmission mechanism is being changed, the control is carried out by using the control change gear ratio calculated based on the predicted rotation speed. Therefore, the deviation of the predicted rotation speed from the actual rotation speed at the control time can be decreased as compared with the case where the motor rotation speed, which is a detected value, is used, so that the motor can be controlled more appropriately. As a result, unexpected fluctuations in torque of the drive shaft, which may be produced when the change gear ratio of the transmission mechanism is changed while torque is delivered from the motor, can be restricted.

The present invention is also directed to a method for controlling a power output apparatus having an internal combustion engine; an electric power-mechanical power input output mechanism which is connected to a drive shaft and also rotatably connected to an output shaft of the internal combustion engine independently of the drive shaft to input and output torque to and from the drive shaft and the output shaft along with the input and output of electric power and mechanical power; a motor capable of delivering mechanical power; a transmission mechanism which is connected to a rotating shaft of the motor and the drive shaft to accomplish gear shift of mechanical power along with the change of change gear ratio between the rotating shaft and the drive shaft; and an accumulator unit capable of sending electric power to and from the electric power-mechanical power input output mechanism and the motor. The method including the steps of: (a) calculating a predicted rotation speed, which is the rotation speed of the motor predicted at the control time, based on a motor rotation speed, which is the rotation speed of the motor; (b) calculating a control change gear ratio, which is the control change gear ratio of the transmission mechanism, based on a drive shaft rotation speed, which is the rotation speed of the drive shaft, and the motor rotation speed when the change gear ratio of the transmission mechanism is not being changed, and calculating the control change gear ratio based on the drive shaft rotation speed and the predicted rotation speed when the change gear ratio of the transmission mechanism is being changed; and (c) controlling the internal combustion engine, the electric power-mechanical power input output mechanism, the motor, and the transmission mechanism so that the torque based on a torque demand required by the drive shaft is delivered to the drive shaft by using the control change gear ratio along with the change of the change gear ratio of the transmission mechanism.

In the control method of the power output apparatus in accordance with the present invention, the predicted rotation speed, which is the rotation speed of motor predicted at the time when the motor is controlled, is calculated based on the motor rotation speed, which is the rotation speed of the motor, and when the change gear ratio of the transmission mechanism is not being changed, the control change gear ratio, which is the control change gear ratio of the transmission mechanism, is calculated based on the drive shaft rotation speed, which is the rotation speed of the drive shaft, and the motor rotation speed, and when the change gear ratio of the transmission mechanism is being changed, the control change gear ratio is calculated based on the drive shaft rotation speed and the predicted rotation speed. Then, the internal combustion engine, the electric power-mechanical power input output mechanism, the motor, and the transmission mechanism are controlled so that the torque based on the torque demand required by the drive shaft is delivered to the drive shaft by using the control change gear ratio along with the change of the change gear ratio of the transmission mechanism. That is to say, when the change gear ratio of the transmission mechanism is not being changed, the internal combustion engine, the electric power-mechanical power input output mechanism, and the motor are controlled so that the torque based on the torque demand required by the drive shaft is delivered to the drive shaft by using the control change gear ratio calculated based on the drive shaft rotation speed and the motor rotation speed, which are detected values, and when the change gear ratio of the transmission mechanism is being changed, the internal combustion engine, the electric power-mechanical power input output mechanism, the motor, and the transmission mechanism are controlled so that the torque based on the torque demand required by the drive shaft is delivered to the drive shaft by using the control change gear ratio calculated based on the drive shaft rotation speed, which is a detected value, and the predicted rotation speed. Thus, when the change gear ratio of the transmission mechanism is being changed, the control is carried out by using the control change gear ratio calculated based on the predicted rotation speed. Therefore, the deviation of the predicted rotation speed from the actual rotation speed at the control time can be decreased as compared with the case where the motor rotation speed, which is a detected value, is used, so that the motor can be controlled more appropriately. As a result, unexpected fluctuations in torque of the drive shaft, which may be produced when the change gear ratio of the transmission mechanism is changed while torque is delivered from the motor, can be restricted.

### BRIEF DESCRIPTION OF THE DRAWINGS

FIG. 1 is a configuration diagram showing the outline of configuration of a hybrid vehicle 20 mounted with a power output apparatus in accordance with one embodiment of the present invention;

FIG. 2 is a configuration view showing the outline of configuration of an engine 22;

FIG. 3 is an explanatory diagram showing one example of the configuration of a transmission 60;

FIG. 4 is an explanatory chart showing one example of the relationship between a battery temperature Tb and input and output limits Win and Wout of a battery 50;

FIG. 5 is an explanatory chart showing one example of the relationship between the state of charge (SOC) of a battery 50 and the correction factors for input and output limits Win and Wout;

FIG. 6 is a flowchart showing one example of a drive control routine executed by a hybrid electronic control unit 70 in accordance with an embodiment;

FIG. 7 is an explanatory chart showing one example of a torque demand setting map;

FIG. 8 is an explanatory chart showing one example of an operation line of an engine 22 and a state in which a target rotation speed Ne* and a target torque Te* are set;

FIG. 9 is an explanatory chart showing one example of an alignment chart showing the dynamic relationship between rotation speed and torque in a rotation element of a power distribution and integration mechanism 30 at the time when a torque demand Tr* is a drive torque for acceleration;

FIG. 10 is an explanatory chart for explaining a state in which torque limits Tm1min and Tm1max are set;

FIG. 11 is an explanatory chart showing one example of a gear shift map;

FIG. 12 is a flowchart showing one example of a shift control routine;

FIG. 13 is an explanatory chart showing one example of an alignment chart of a transmission 60 at the time of Lo-Hi shift and Hi-Lo shift;

FIG. 14 is an explanatory chart showing one example of a hydraulic sequence in a hydraulic circuit for controlling the drive of brakes B1 and B2 of a transmission 60 at the time of Lo-Hi shift;

FIG. 15 is an explanatory chart showing one example of a hydraulic sequence in a hydraulic circuit for controlling the drive of brakes B1 and B2 of a transmission 60 at the time of Hi-Lo shift;

FIG. 16 is a configuration view showing the outline of configuration of a hybrid vehicle 120 of a modified example; and

FIG. 17 is a configuration view showing the outline of configuration of a hybrid vehicle 220 of another modified example.

### DESCRIPTION OF THE PREFERRED EMBODIMENTS

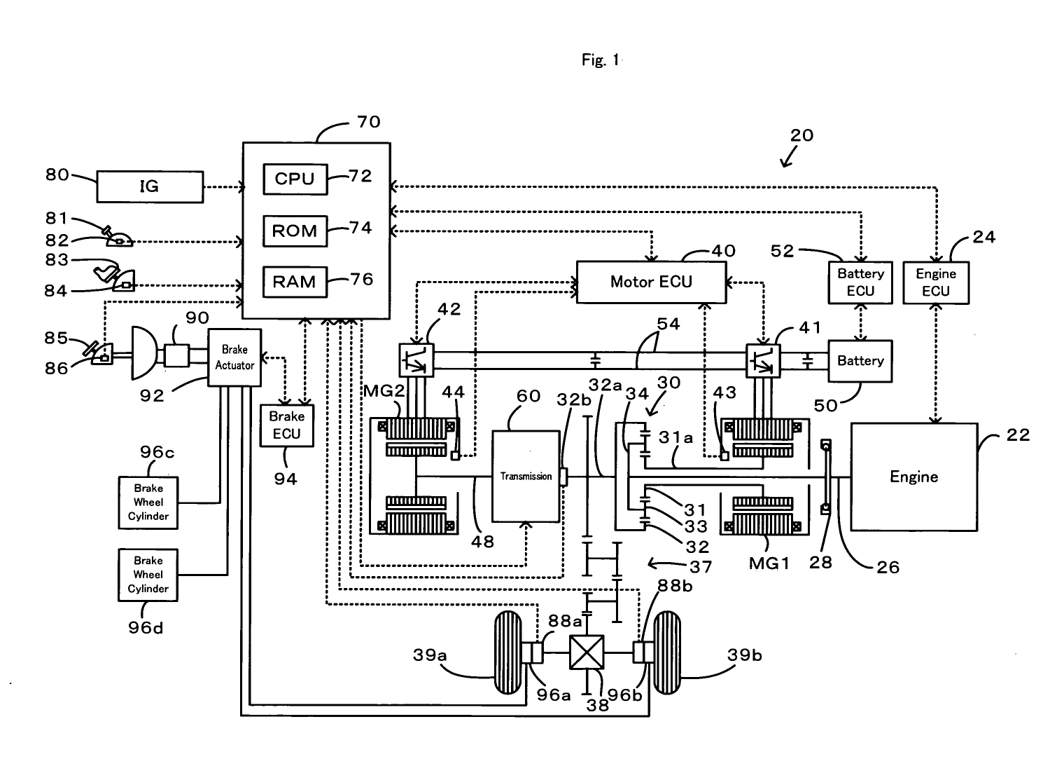

A preferred embodiment of the present invention will now be described. FIG. 1 is a configuration diagram showing the outline of configuration of a hybrid vehicle 20 mounted with a power output apparatus in accordance with one embodiment of the present invention. As shown in FIG. 1, the hybrid vehicle 20 of this embodiment includes an engine 22, a three shaft-type power distribution and integration mechanism 30 connected to a crankshaft 26 serving as an output shaft of the engine 22 via a damper 28, a motor MG1 capable of generating electric power, which is connected to the power distribution and integration mechanism 30, a motor MG2 connected to the power distribution and integration mechanism 30 via a transmission 60, a brake actuator 92 for controlling the brakes for drive wheels 39a and 39b and driven wheels, not shown, and a hybrid electronic control unit 70 for controlling the whole of drive system of vehicle.

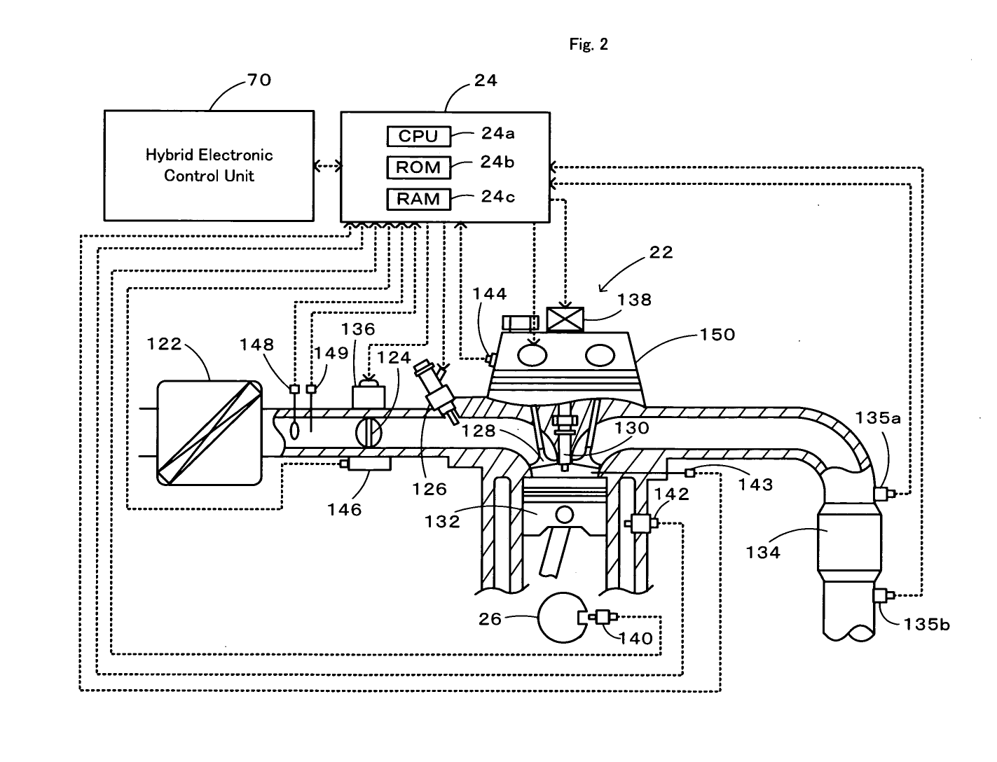

The engine 22 is an internal combustion engine that consumes a hydrocarbon fuel, such as gasoline or light oil, to output power. As shown in FIG. 2, the air cleaned by an air cleaner 122 and taken in via a throttle valve 124 is mixed with the atomized gasoline injected by a fuel injection valve 126 to the air-fuel mixture. The air-fuel mixture is introduced into a combustion chamber via an intake valve 128. The introduced air-fuel mixture is ignited with spark made by a spark plug 130 to be explosively combusted. The reciprocating motions of a piston 132 by the combustion energy are converted into rotational motions of a crankshaft 26. The exhaust from the engine 22 goes through a catalytic conversion unit 134 (filled with three-way catalyst) to convert toxic components included in the exhaust, that is, carbon monoxide (CO), hydrocarbons (HC), and nitrogen oxides (NOx), into harmless components, and is discharged to the outside air.

The engine 22 is controlled by an engine electronic control unit (hereinafter referred to as an engine ECU) 24. The engine ECU 24 is configured as a microprocessor mainly including a CPU 24a, and has, in addition to the CPU 24a, a ROM 24b for storing processing programs, a RAM 24c for storing data temporarily, and input and output ports and a communication port, not shown. To the engine ECU 24, signals from various sensors for detecting the state of the engine 22, for example, a crank position from a crank position sensor 140 for detecting the rotational position of the crankshaft 26, a cooling water temperature from a water temperature sensor 142 for detecting the temperature of cooling water for the engine 22, an in-cylinder pressure Pin from a pressure sensor 143 provided in a combustion chamber, a cam position from a cam position sensor 144 for detecting the rotational position of a camshaft that opens and closes the intake valve 128 and an exhaust valve for performing air supply and exhaust to and from the combustion chamber, a throttle position from a throttle valve position sensor 146 for detecting the position of the throttle valve 124, an air flowmeter signal AF from an air flowmeter 148 attached to an intake pipe, an intake air temperature from a temperature sensor 149 attached to the intake pipe in the same way, an air-fuel ratio AF from an air-fuel ratio sensor 135a, and an oxygen signal from an oxygen sensor 135b are sent via the input port. Also, from the engine ECU 24, various control signals for driving the engine 22, for example, a drive signal to the fuel injection valve 126, a drive signal to a throttle motor 136 for regulating the position of the throttle valve 124, a control signal to an ignition coil 138 integrated with an igniter, and a control signal to a variable valve timing mechanism 150 capable of changing the opening and closing timing of the intake valve 128 are sent out via the output port. The engine ECU 24 communicates with the hybrid electronic control unit 70, so that based on a control signal from the hybrid electronic control unit 70, the engine ECU 24 controls the operation of the engine 22, and also sends out data about the operating state of the engine 22 as necessary. The engine ECU 24 also calculates the rotation speed of the crankshaft 26, that is, the rotation speed Ne of the engine 22 based on a crank position sent from the crank position sensor 140.

The power distribution and integration mechanism 30 includes a sun gear 31 of an external gear, a ring gear 32 of an internal gear that is arranged on a concentric circle concentric with the sun gear 31, a plurality of pinion gears 33 engaging with the sun gear 31 and the ring gear 32, and a carrier 34 for holding the pinion gears 33 so that they are capable of rotating and revolving freely, and is configured as a planetary gear mechanism that performs a differential operation with the sun gear 31, the ring gear 32, and the carrier 34 being rotating elements. The power distribution and integration mechanism 30 is configured so that the crankshaft 26 of the engine 22 is connected to the carrier 34, the motor MG1 is connected to the sun gear 31, and the motor MG2 is connected to the ring gear 32 via the transmission 60. When the motor MG1 functions as a generator, the power from the engine 22, which is inputted from the carrier 34, is distributed to the sun gear 31 side and the ring gear 32 side according to the gear ratio. When the motor MG1 functions as a motor, the power from the engine 22, which is inputted from the carrier 34, and the power from the motor MG1, which is inputted from the sun gear 31, are integrated and outputted to the ring gear 32. The ring gear 32 is connected mechanically to the drive wheels 39a and 39b of the vehicle front wheels via a gear mechanism 37 and a differential gear 38. Therefore, the power outputted to the ring gear 32 is sent to the drive wheels 39a and 39b via the gear mechanism 37 and the differential gear 38. Three axes connected to the power distribution and integration mechanism 30 as viewed as a drive system are the crankshaft 26 that is the output shaft of the engine 22 connected to the carrier 34, a sun gear shaft 31a that is connected to the sun gear 31 and serves as the rotating shaft of the motor MG1, and a ring gear shaft 32a that is connected to the ring gear 32 and serves as a drive shaft mechanically connected to the drive wheels 39a and 39b.

Both of the motors MG1 and MG2 are configured as well-known synchronous motor generators each of which can be driven as a generator and also can be driven as a motor, and sends and receives electric power to and from a battery 50 via inverters 41 and 42. Power lines 54 that connect the inverters 41 and 42 to the battery 50 are configured as a positive electrode bus line and a negative electrode bus line that are used commonly by the inverters 41 and 42, so that the electric power generated by one of the motors MG1 and MG2 can be consumed by the other of the motors. The drive of the motors MG1 and MG2 is controlled by a motor electronic control unit (hereinafter referred to as a motor ECU) 40. To the motor ECU 40, signals necessary for controlling the drive of the motors MG1 and MG2, for example, signals from rotational position detection sensors 43 and 44 for detecting the rotational position of the rotors of the motors MG1 and MG2 and a phase current applied to the motors MG1 and MG2 detected by a current sensor, not shown, are sent. From the motor ECU 40, switching control signals to the inverters 41 and 42 are sent out. The motor ECU 40 calculates the rotation speeds Nm1 and Nm2 of the rotors of the motors MG1 and MG2 by a rotation speed calculation routine, not shown, based on the signal sent from the rotational position detection sensors 43 and 44. The motor ECU 40 communicates with the hybrid electronic control unit 70, so that the motor ECU 40 controls the drive of the motors MG1 and MG2 based on a control signal from the hybrid electronic control unit 70, and also sends out data about the operating states of the motors MG1 and MG2 to the hybrid electronic control unit 70 as necessary. The motor ECU 40 also calculates the rotation speeds Nm1 and Nm2 of the motors MG1 and MG2 based on the signals from the rotational position detection sensors 43 and 44.

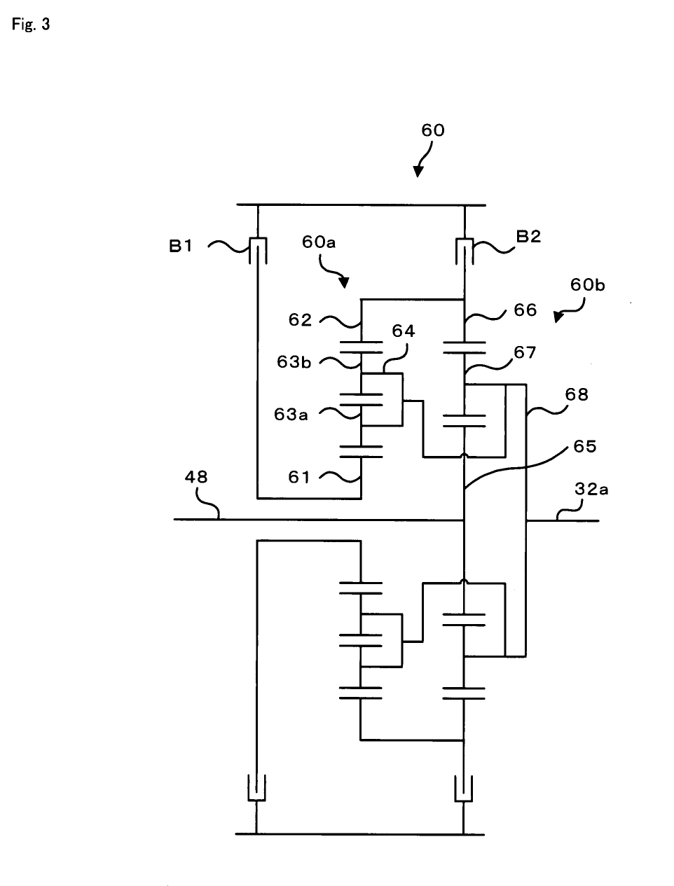

The transmission 60 is configured so as to connect and disconnect the ring gear shaft 32a to and from a rotating shaft 48 of the motor MG2 and also transmit the connection of both shafts to the ring gear shaft 32a by reducing the rotation speed of the rotating shaft 48 of the motor MG2 in two stages. One example of configuration of the transmission 60 is shown in FIG. 3. The transmission 60 shown in FIG. 3 is made up of a planetary gear mechanism 60a of double pinion, a planetary gear mechanism 60b of single pinion, and two brakes B1 and B2. The planetary gear mechanism 60a of double pinion includes a sun gear 61 of an external gear, a ring gear 62 of an internal gear that is arranged on a concentric circle concentric with the sun gear 61, a plurality of first pinion gears 63a engaging with the sun gear 61, a plurality of second pinion gears 63b engaging with the first pinion gears 63a and the ring gear 62, and a carrier 64 for connectingly holding the first pinion gears 63a and second pinion gears 63b so that they are capable of rotating and revolving freely. The sun gear 61 is configured so that the rotation thereof can be stopped and freed by the on and off of the brake B1. The planetary gear mechanism 60b of single pinion includes a sun gear 65 of an external gear, a ring gear 66 of an internal gear that is arranged on a concentric circle concentric with the sun gear 65, a plurality of pinion gears 67 engaging with the sun gear 65 and the ring gear 66, and a carrier 68 for holding the pinion gears 67 so that they are capable of rotating and revolving freely. The sun gear 65 is connected to the rotating shaft 48 of the motor MG2, and the carrier 68 is connected to the ring gear shaft 32a. Also, the ring gear 66 is configured so that the rotation thereof can be stopped and freed by the on and off of the brake B2. The planetary gear mechanism 60a of double pinion and the planetary gear mechanism 60b of single pinion are connected to each other by the ring gear 62 and ring gear 66 and by the carrier 64 and the carrier 68, respectively. The transmission 60 can disconnect the rotating shaft 48 of the motor MG2 from the ring gear shaft 32a by turning both of the brakes B1 and B2 off. By turning the brake B1 off and turning the brake B2 on, the rotation of the rotating shaft 48 of the motor MG2 is transmitted to the ring gear shaft 32a while the rotation speed is reduced at a relatively high speed reduction ratio (hereinafter, this state is referred to as an Lo gear state). By turning the brake B1 on and turning the brake B2 off, the rotation of the rotating shaft 48 of the motor MG2 is transmitted to the ring gear shaft 32a while the rotation speed is reduced at a relatively low speed reduction ratio (hereinafter, this state is referred to as an Hi gear state). The state in which both of the brakes B1 and B2 are on prohibits the rotation of the rotating shaft 48 and the ring gear shaft 32a.

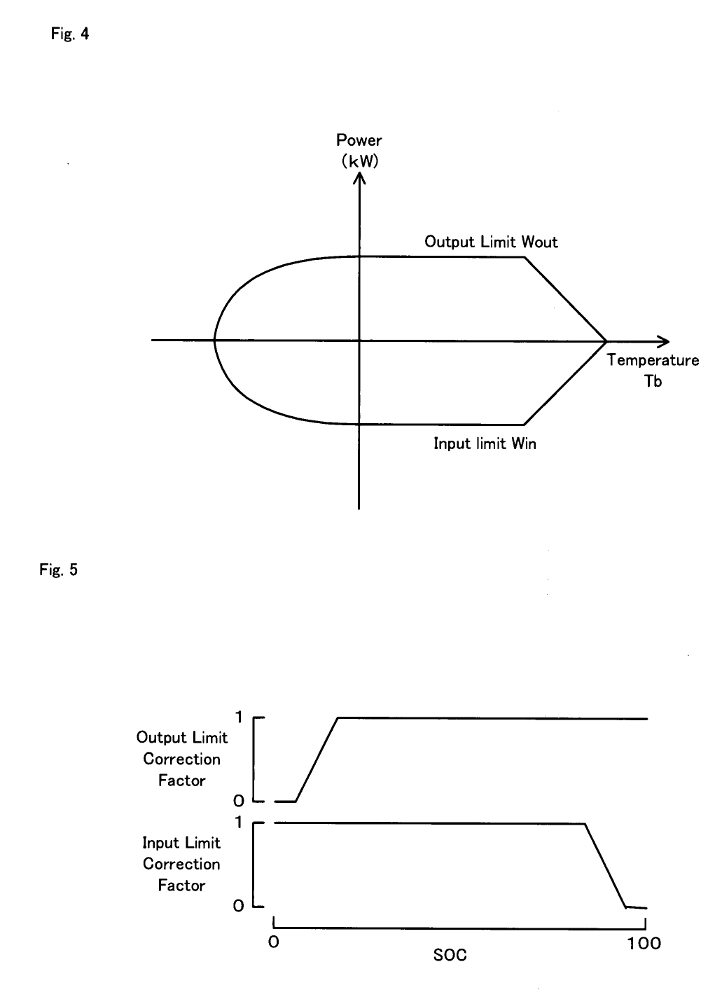

The battery 50 is controlled by a battery electronic control unit (hereinafter referred to as a battery ECU) 52. To the battery ECU 52, signals necessary for controlling the battery 50, for example, an inter-terminal voltage from a voltage sensor, not shown, provided between the terminals of the battery 50, a charge-discharge current from a current sensor, not shown, attached to the power line 54 connected to the output terminal of the battery 50, and a battery temperature from a temperature sensor, not shown, attached to the battery 50 are sent. From the battery ECU 52, data about the state of the battery 50 are sent out to the hybrid electronic control unit 70 by communication as necessary. Also, the battery ECU 52 calculates the state of charge (SOC) based on the integrated value of the charge-discharge current detected by the current sensor to control the battery 50, and calculates the input and output limits Win and Wout, which are maximum allowable power that allows the charge and discharge of the battery 50, based on the calculated state of charge (SOC) and the battery temperature Tb. The input and output limits Win and Wout of the battery 50 can be set by setting the basic values of the input and output limits Win and Wout based on the battery temperature Tb, by setting an output limit correction factor and an input limit correction factor based on the state of charge (SOC) of the battery 50, and by multiplying the set basic values of the input and output limits Win and Wout by a correction factor. FIG. 4 shows one example of the relationship between the battery temperature Tb and the input and output limits Win and Wout, and FIG. 5 shows one example of the relationship between the state of charge (SOC) of a battery 50 and the correction factors for the input and output limits Win and Wout.

The brake actuator 92 is configured so that the hydraulic pressures in brake wheel cylinders 96a to 96d can be regulated so that the braking torque according to the allotment of the brake in the braking force applied to the vehicle by the pressure of a brake master cylinder 90 (brake pressure) produced according to the depression of a brake pedal 85 is applied to the drive wheels 39a and 39b and driven wheels, not shown, or so that the hydraulic pressures in the brake wheel cylinders 96a to 96d can be regulated so that the braking torque is applied to the drive wheels 39a and 39b and driven wheels independently of the depression of the brake pedal 85. The brake actuator 92 is controlled by a brake electronic control unit (hereinafter referred to as a brake ECU) 94. The brake ECU 94 receives signals such as a wheel speed sent from a wheel speed sensor, not shown, attached to the drive wheels 39a and 39b and driven wheels and a steering angle sent from a steering angle sensor, not shown, and carries out an antilock braking system (ABS) function for preventing either of the drive wheels 39a and 39b and driven wheels from slipping due to locking when the driver depresses the brake pedal 85, traction control (TRC) for preventing either of the drive wheels 39a and 39b and driven wheels from slipping due to racing when the driver depresses an accelerator pedal 83, vehicle stability control (VSC) for holding the vehicle posture when the vehicle turns, and the like. The brake ECU 94 communicates with the hybrid electronic control unit 70, so that the brake ECU 94 controls the drive of the brake actuator 92 based on the control signal from the hybrid electronic control unit 70, and sends out data about the state of the brake actuator 92 to the hybrid electronic control unit 70 as necessary.

The hybrid electronic control unit 70 is configured as a microprocessor mainly including a CPU 72, and has, in addition to the CPU 72, a ROM 74 for storing processing programs, a RAM 76 for storing data temporarily, and input and output ports and a communication port, not shown. To the hybrid electronic control unit 70, an ignition signal from an ignition switch 80, a shift position SP from a shift position sensor 82 for detecting the operation position of a shift lever 81, an accelerator opening Acc from an accelerator pedal position sensor 84 for detecting the accelerator opening Acc corresponding to the depression stroke of the accelerator pedal 83, a brake position BP from a brake pedal position sensor 86 for detecting the depression stroke of the brake pedal 85, wheel speeds Vwa to Vwd from wheel speed sensors 88a to 88d attached to the drive wheels 39a and 39b and driven wheels, not shown, a drive shaft rotation speed Nr from a rotation speed sensor 32b attached to the ring gear shaft 32a serving as a drive shaft, and the like are sent via the input port. Also, from the hybrid electronic control unit 70, a drive signal to actuators, not shown, for the brakes B1 and B2 of the transmission 60 and the like signals are sent out via the output port. As described above, the hybrid electronic control unit 70 is connected to the engine ECU 24, the motor ECU 40, the battery ECU 52, and the brake ECU 94 via the communication port. Therefore, various control signals and data are sent from the hybrid electronic control unit 70 to the engine ECU 24, the motor ECU 40, the battery ECU 52, and the brake ECU 94 and vice versa. The hybrid electronic control unit 70 of this embodiment calculates a vehicle speed V by a vehicle speed calculation routine, not shown, based on the wheel speeds Vwa to Vwd sent from the wheel speed sensors 88a to 88d. As the vehicle speed V, for example, an average value of the wheel speeds Vwa to Vwd may be used, or an average value of three wheel speeds having a small wheel speed difference of the wheel speeds Vwa to Vwd may be used.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a.

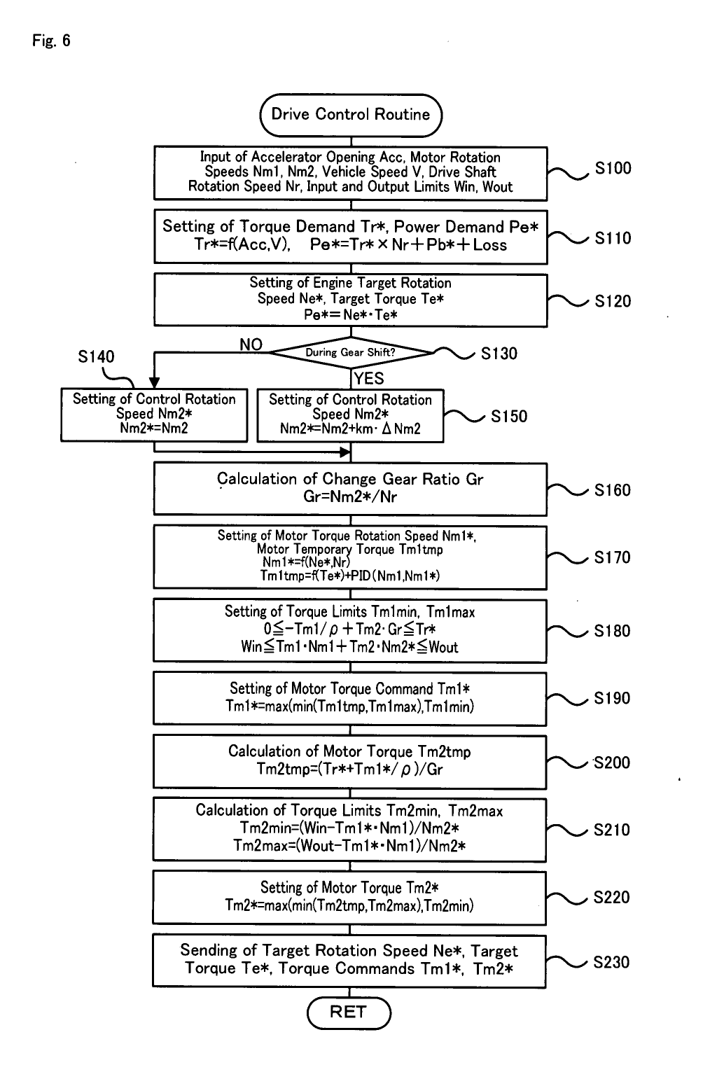

Next, the operation of the hybrid vehicle 20 in accordance with this embodiment, especially the operation at the time when the shift stage of the transmission 60 is changed, is explained. First, the drive control for delivering power to the ring gear shaft 32a serving as a drive shaft is explained, and thereafter the shift control of the transmission 60 is explained. FIG. 6 is a flowchart showing one example of a drive control routine executed by the hybrid electronic control unit 70. This routine is executed repeatedly at predetermined time intervals (for example, at several milliseconds intervals).

When the drive control routine is executed, the CPU 72 of the hybrid electronic control unit 70 first executes processing for inputting data necessary for control, such as the accelerator opening Acc from the accelerator pedal position sensor 84, the vehicle speed V, the rotation speeds Nm1 and Nm2 of the motors MG1 and MG2, the drive shaft rotation speed Nr from the rotation speed sensor 32b, and the input and output limits Win and Wout of the battery 50 (Step S100). In this step, for the rotation speeds Nm1 and Nm2 of the motors MG1 and MG2, rotation speeds calculated based on the rotational positions of rotors of the motors MG1 and MG2, which are detected by the rotational position detection sensors 43 and 44, are inputted by communication from the motor ECU 40. Also, for the vehicle speed V, a speed that is calculated based on the wheel speeds Vwa to Vwd from the wheel speed sensors 88a to 88d and is stored in a predetermined region of the RAM 76 is inputted by reading. Further, for the input and output limits Win and Wout of the battery 50, limits set based on the battery temperature Tb of the battery 50 and the state of charge (SOC) of the battery 50 is inputted by communication from the battery ECU 52.

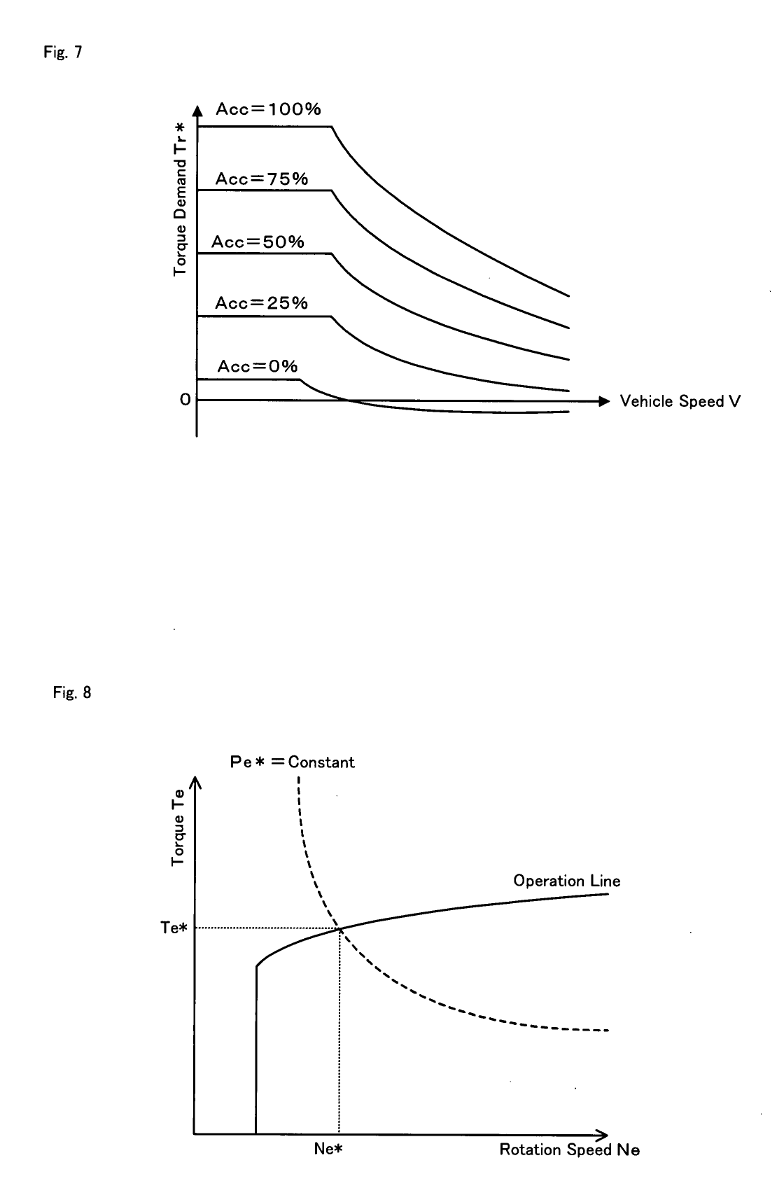

After the data have been inputted in this manner, a torque demand Tr* to be outputted to the ring gear shaft 32a serving as the drive shaft connected to the drive wheels 39a and 39b as a torque required for the vehicle based on the inputted accelerator opening Acc and vehicle speed V and a power demand Pe* required for the engine 22 are set (Step S110). In this embodiment, the torque demand Tr* is set by storing the relationship between the accelerator opening Acc and vehicle speed V and the torque demand Tr*, which has been determined in advance, in the ROM 74 as a torque demand setting map and by deriving the corresponding torque demand Tr* from the stored map when the accelerator opening Acc and vehicle speed V are given. FIG. 7 shows one example of the torque demand setting map. The power demand Pe* can be calculated as the sum of a value obtained by multiplying the set torque demand Tr* by the drive shaft rotation speed Nr and a charge/discharge power demand Pb* required by the battery 50 and a loss Loss.

Successively, a target rotation speed Ne* and a target torque Te* are set based on the set power demand Pe* as an operation point at which the engine 22 should be operated (Step S120). This setting operation is performed based on an operation line that operates the engine 22 efficiently and the power demand Pe*. FIG. 8 shows one example of the operation line of the engine 22 and the state in which the target rotation speed Ne* and the target torque Te* are set. As shown in FIG. 8, the target rotation speed Ne* and the target torque Te* can be determined by the intersection of the operation line and a curve on which the power demand Pe* (Ne*×Te*) is constant.

Next, it is judged whether or not the shift stage of the transmission 60 is being changed (Step S130). When the shift stage of the transmission 60 is not being changed, the inputted rotation speed Nm2 of the motor MG2 is set as a control rotation speed Nm2* (Step S140). When the shift stage of the transmission 60 is being changed, a rotation speed that is obtained by adding a value obtained by multiplying a difference ΔNm2, which is obtained by subtracting the rotation speed Nm2 of the motor MG2 inputted when this routine was executed previously from the rotation speed Nm2 of the motor MG2, by a gain km to the rotation speed Nm2 of the motor MG2 is set as the control rotation speed Nm2*(Step S150). The change gear ratio Gr of the transmission 60 is calculated by dividing the set control rotation speed Nm2* by the drive shaft rotation speed Nr (Step S160). Considering that this routine is executed at the predetermined time intervals (for example, at several milliseconds intervals), the difference ΔNm2 is a time differential component of the rotation speed Nm2 of the motor MG2. Therefore, if the gain km is adjusted, the control rotation speed Nm2* considering a value obtained by multiplying the time differential component by the gain km approaches the rotation speed of the motor MG2 at the control time, that is, the rotation speed of the motor MG2 predicted at the control time. When a change in rotation speed of the motor MG2 is great, for example, when the shift stage of the transmission 60 is being changed, considering that the rotation speed Nm2 of the motor MG2 is calculated based on the signal sent from the rotation position detection sensor 44 and that the rotation speed Nm2 of the motor MG2 is sent to the hybrid electronic control unit 70 by communication, deviation of the actual rotation speed from the inputted rotation speed Nm2 of the motor MG2 is induced by sensing delay, calculation delay, or communication delay. Therefore, in this embodiment, to reduce such deviation, when the shift stage of the transmission 60 is being changed, the rotation speed at the control time is predicted by adding the value obtained by multiplying the time differential component of the rotation speed Nm2 by the gain km to the rotation speed Nm2, and this predicted rotation speed is controlled as the control rotation speed Nm2*. By calculating the change gear ratio Gr of the transmission 60 by using this control rotation speed Nm2*, the change gear ratio Gr at the time when the shift stage of the transmission 60 is being changed is made more appropriate. The gain km has been adjusted so that the rotation speed predicted at the control time is provided.

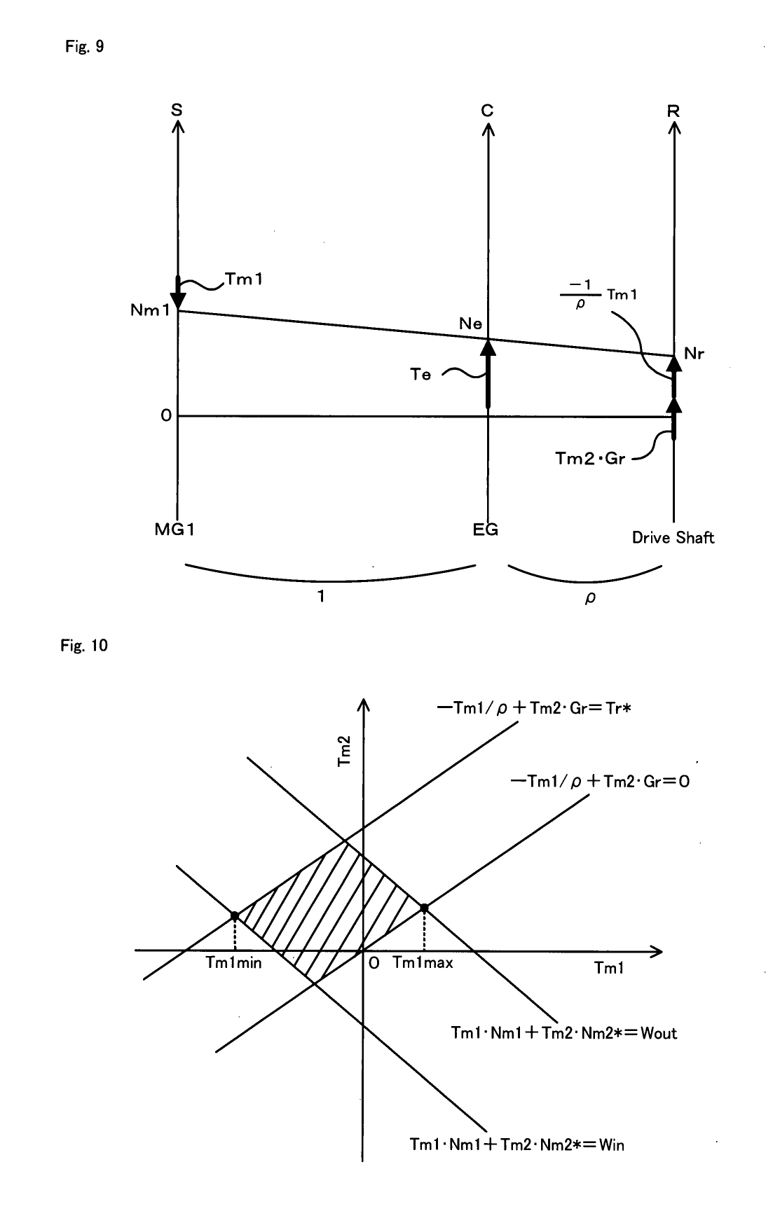

Next, the target rotation speed Nm1* of the motor MG1 is calculated by Equation (1) using the target rotation speed Ne* of the engine 22, the rotation speed Nm2 of the motor MG2, and the gear ratio ρ of the power distribution and integration mechanism 30, and also a temporary torque Tm1tmp, which is a temporary value of torque to be delivered from the motor MG1, is calculated by Equation (2) based on the calculated target rotation speed Nm1* and the inputted rotation speed Nm1 of the motor MG1 (Step S170). Herein, Equation (1) is a dynamic relational expression for the rotation element of the power distribution and integration mechanism 30. FIG. 9 is an alignment chart showing the dynamic relationship between rotation speed and torque in the rotation element of the power distribution and integration mechanism 30 at the time when the vehicle is running in the state in which power is generated from the engine 22. In FIG. 9, the left S axis represents the rotation speed of the sun gear 31, which is the rotation speed Nm1 of the motor MG1, the C axis represents the rotation speed of the carrier 34, which is the rotation speed Ne of the engine 22, and the R axis represents the rotation speed Nr of the ring gear 32 (the drive shaft rotation speed Nr). Equation (1) can be derived easily by using this alignment chart. Two thick arrow marks on the R axis indicate a torque applied to the ring gear shaft 32a by the torque Tm1 delivered from the motor MG1 and a torque applied to the ring gear shaft 32a via a reduction gear 35 by the torque Tm2 delivered from the motor MG2. Also, Equation (2) is a relational expression in the feedback control for rotating the motor MG1 at the target rotation speed Nm1*. In Equation (2), “k1” in the second term on the right-hand side is the gain of proportional term, and “k2” in the third term on the right-hand side is the gain of integral term.

Nm1*=Ne*·(1+ρ)/ρ−Nm2/ρ (1)

Tm1tmp=ρ·Te*/(1+ρ)+k1(Nm1*−Nm1)+K2∫(Nm1*−Nm1)dt (2)

Successively, torque limits Tm1min and Tm1max are set as the upper and lower limits of torque that may be delivered from the motor MG1 satisfying both of Equation (3) and Equation (4) (Step S180). A torque command Tm1* is set by restricting the set temporary torque Tm1tmp by means of the torque limits Tm1min and Tm1max by Equation (5) (Step S190). Herein, Equation (3) represents the relationship such that the sum of torques delivered to the ring gear shaft 32a by the motor MG1 and the motor MG2 is in the range of value 0 to the torque demand Tr*, and Equation (4) represents the relationship such that the sum of electric powers generated and received by the motor MG1 and the motor MG2 is in the range of the input limit Win to the output limit Wout. One example of torque limits Tm1min and Tm1max is shown in FIG. 10. The torque limits Tm1min and Tm1max can be determined as the maximum value and the minimum value of the torque command Tm1* in the region shown by hatching in FIG. 10. As shown in Equations (3) and (4), the torque limits Tm1min and Tm1max are set by using the control rotation speed Nm2* and the change gear ratio Gr calculated by using this control rotation speed Nm2*, so that even when the shift stage of the transmission 60 is being changed, the torque limits Tm1min and Tm1max can be set more appropriately.

0≦−Tm1/ρ+Tm2·Gr≦Tr* (3)

Win≦Tm1·Nm1+Tm2·Nm2*≦Wout (4)

Tm1*=max(min(Tm1tmp,Tm1max),Tm1min) (5)

Then, a temporary torque Tm2tmp, which is the temporary value of torque to be delivered from the motor MG2, is calculated by Equation (6) by adding a value obtained by dividing the torque command Tm1* by the gear ratio ρ of the power distribution and integration mechanism 30 to the torque demand Tr* and further by dividing the added result by the change gear ratio Gr of the transmission (Step S200), and torque limits Tm2min and Tm2max are calculated by Equations (7) and (8) as the upper and lower limits of torque that may be delivered from the motor MG2 by dividing a difference between the input and output limit Win, Wout of the battery 50 and the consumed power (generated power) of the motor MG1 obtained by multiplying the set torque command Tm1* by the rotation speed Nm1 of the motor MG1 by the control rotation speed Nm2*(Step S210). Then, the torque command Tm2* of the motor MG2 is set by restricting the set temporary torque Tm2tmp by means of the torque limits Tm2min and Tm2max by Equation (9) (Step S220). Herein, Equation (6) can be derived easily from the alignment chart of FIG. 9. As shown in Equations (6), (7) and (8), the temporary torque Tm2tmp and the torque limits Tm2min and Tm2max are set by using the control rotation speed Nm2* and the change gear ratio Gr calculated by using this control rotation speed Nm2*, so that even when the shift stage of the transmission 60 is being changed, the temporary torque Tm2tmp and the torque limits Tm2min and Tm2max can be set more appropriately.

Tm2tmp=(Tr*+Tm1*/ρ)/Gr (6)

Tm2min=(Win−Tm1*·Nm1)/Nm2* (7)

Tm2max=(Wout−Tm1*Nm1)/Nm2* (8)

Tm2*=max(min(Tm2tmp,Tm2max),Tm2min) (9)

After the target rotation speed Ne* and the target torque Te* of the engine 22 and the torque commands Tm1* and Tm2* of the motors MG1 and MG2 have been set as described above, the target rotation speed Ne* and the target torque Te* of the engine 22 are sent to the engine ECU 24, and the torque commands Tm1* and Tm2* of the motors MG1 and MG2 are sent to the motor ECU 40 (Step S230), by which the drive control routine is finished.

The engine ECU 24 that has received the target rotation speed Ne* and the target torque Te* carries out intake air quantity control, fuel injection control, ignition control, and the like control in the engine 22 so that the engine 22 is operated at the operation point represented by the target rotation speed Ne* and the target torque Te*. Also, the motor ECU 40 that has received the torque commands Tm1* and Tm2* carries out switching control of switching elements of the inverters 41 and 42 so that the motor MG1 is driven by the torque command Tm1* and the motor MG2 is driven by the torque command Tm2*. By such control, even when the shift stage of the transmission 60 is not being changed or is being changed, the engine 22 is operated efficiently within the range of the input limit Win to the output limit Wout of the battery 50, and thereby the vehicle can be run while the torque demand Tr* is outputted to the ring gear shaft 32a serving as a drive shaft.

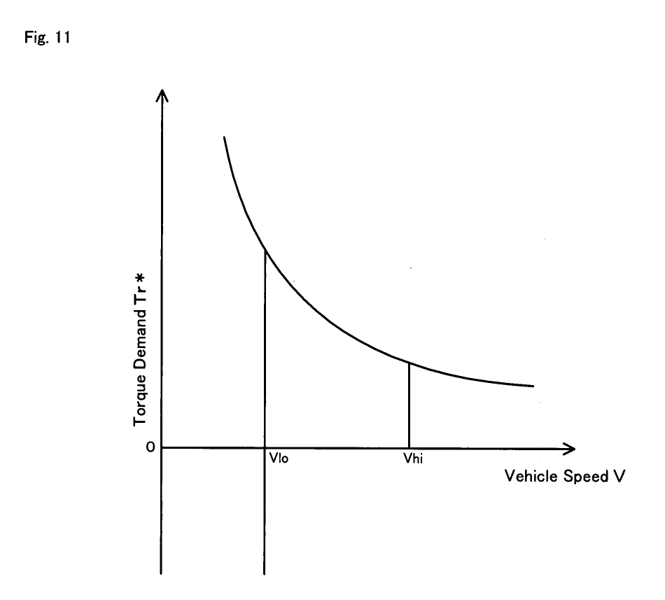

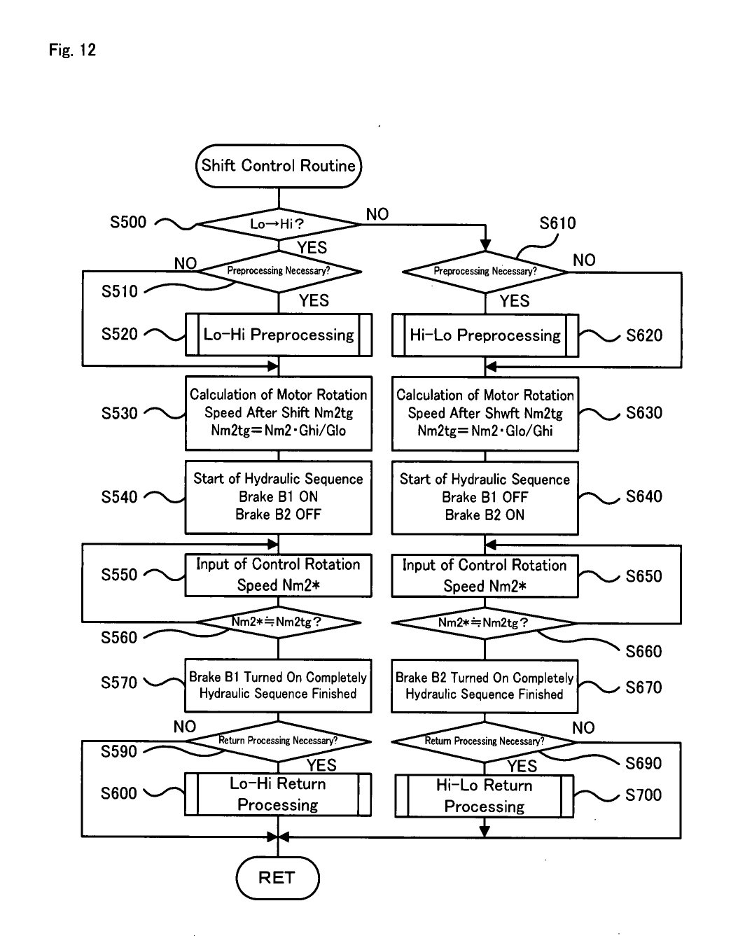

Next, the shift control at the time when the shift stage of the transmission 60 is changed is explained. The shift stage of the transmission 60 is changed when it is judged that either an Lo-Hi shift or an Hi-Lo shift is accomplished as the result of judgment as to whether or not an Lo-Hi shift in which the state of the transmission 60 is changed from an Lo gear state to an Hi gear state based on the vehicle speed V and the torque demand Tr* required by the vehicle is accomplished and judgment as to whether or not an Hi-Lo shift in which the state of the transmission 60 is changed from the Hi gear state to the Lo gear state based on the vehicle speed V and the torque demand is accomplished. One example of a gear shift map for accomplishing a shift is shown in FIG. 11. In the example shown in FIG. 11, when the vehicle speed V increases beyond an Lo-Hi shift line Vhi in the state in which the transmission 60 is in the Lo gear state, the state of the transmission 60 is changed from the Lo gear state to the Hi gear state, and when the vehicle speed V decreases beyond an Hi-Lo shift line Vlo in the state in which the transmission 60 is in the Hi gear state, the state of the transmission 60 is changed from the Hi gear state to the Lo gear state. The shift stage of the transmission 60 is changed by executing a shift control routine typically shown in FIG. 12.

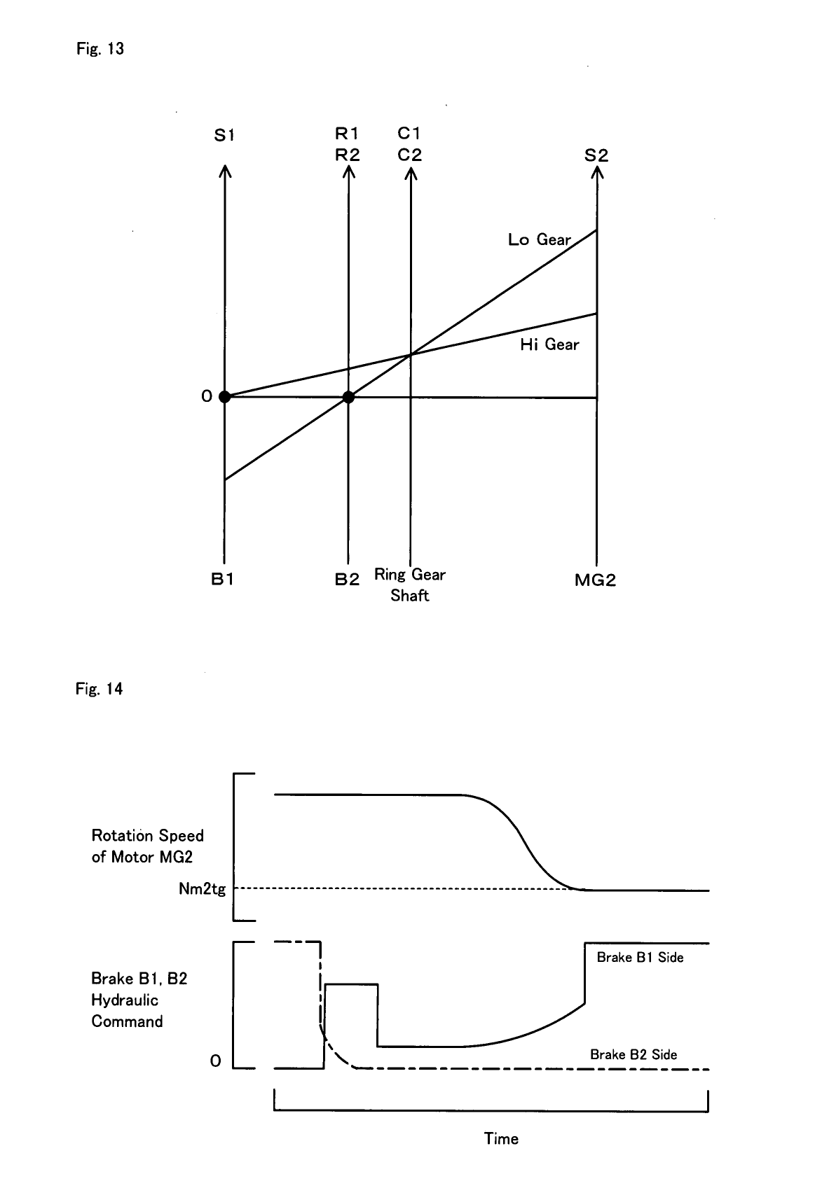

In this shift control routine, first, it is judged whether the shift of shift stage of the transmission 60 is the Lo-Hi shift in which the Lo gear state is changed to the Hi gear state or the Hi-Lo shift in which the Hi gear state is changed to the Lo gear state (Step S500). At the time of Lo-Hi shift, Lo-Hi preprocessing is executed if the preprocessing is necessary before the Lo-Hi shift (Steps S510 and S520). Herein, as the Lo-Hi preprocessing, torque decreasing processing and the like can be cited. In the torque decreasing processing, when a shift shock is produced at the time of Lo-Hi shift or the Hi-Lo shift cannot be accomplished smoothly because the torque delivered from the motor MG2 is high, the torque delivered from the motor MG2 is decreased to torque of a degree to which the Lo-Hi shift can be accomplished smoothly. When the Lo-Hi preprocessing is unnecessary, or after the Lo-Hi preprocessing has been performed, a target rotation speed Nm2tg, which is the rotation speed of the motor MG2 after shift, is calculated by Equation (10) using the present rotation speed Nm2 of the motor MG2 and change gear ratios Glo and Ghi of the transmission 60 (Step S530). Then, to turn the brake B1 of the transmission 60 on with friction engagement and to turn the brake B2 thereof off, a hydraulic sequence for a hydraulically driven actuator, not shown, of the transmission 60 is started (Step S540). One example of an alignment chart of a transmission 60 at the time of Lo-Hi shift and Hi-Lo shift is shown in FIG. 13, and one example of the hydraulic sequence of Lo-Hi shift is shown in FIG. 14. In FIG. 13, the S1 axis represents the rotation speed of the sun gear 61 of the planetary gear mechanism 60a of double pinion, the R1 and R2 axes represent the rotation speeds of the ring gears 62 and 66 of the planetary gear mechanism 60a of double pinion and the planetary gear mechanism 60b of single pinion, respectively, the C1 and C2 axes represent the rotation speeds of the carriers 64 and 68 of the planetary gear mechanism 60a of double pinion and the planetary gear mechanism 60b of single pinion, respectively, which are the rotation speed of the ring gear shaft 32a, and the S2 axis represents the rotation speed of the sun gear 65 of the planetary gear mechanism 60b of single pinion, which is the rotation speed of the motor MG2. As shown in FIG. 13, in the state of Lo gear, the brake B2 is turned on and the brake B1 is turned off. When the brake B2 is turned on from this state, the motor MG2 becomes in a state of being separated from the ring gear shaft 32a. Since a positive torque is delivered from the motor MG2 functioning as a motor, the rotation speed tends to increase. Herein, when the brake B1 is friction engaged, the rotation speed of the motor MG2 decreases. When the rotation speed, that is, the control rotation speed Nm2* of the motor MG2 comes close to the target rotation speed Nm2tg in the Hi gear state, the brake B1 is completely turned on from the friction engagement, by which the transmission state can be changed over to the Hi gear state. Also, in FIG. 14, a large hydraulic command of the brake B1 immediately after the start of sequence is due to a first fill for filling oil in the cylinder before an engagement force is applied to the brake B1. After the control rotation speed Nm2* of the motor MG2 has come close to the rotation speed Nm2tg after shift (Steps S550 and S560), the brake B1 is completely turned on to finish the hydraulic sequence (Step S570), and also when the Lo-Hi preprocessing has been performed, Lo-Hi return processing, which is a return processing reverse to the Lo-Hi preprocessing, is performed (Steps S590 and S600) to finish the shift processing. Even in the control of Lo-Hi shift as described above, control can be carried out more appropriately by using the control rotation speed Nm2* as the rotation speed of the motor MG2.

Nm2tg=Nm2·Ghi/Glo (10)

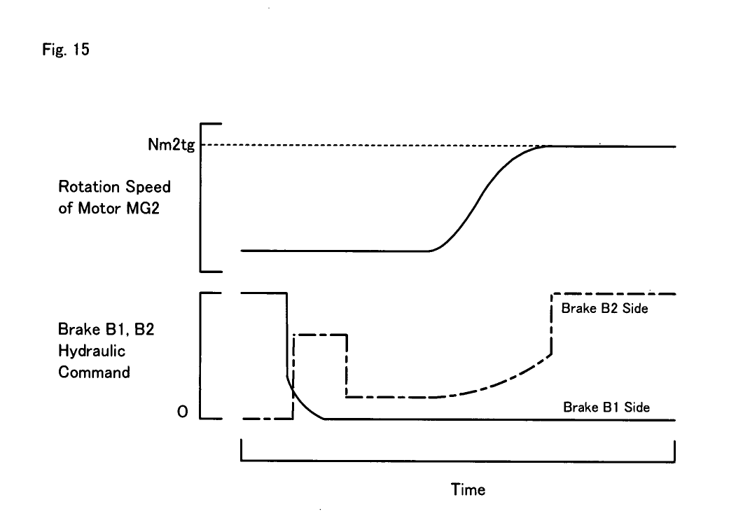

If it is judged in Step S500 that the shift of the transmission 60 is the Hi-Lo shift, Hi-Lo preprocessing is executed if the preprocessing is necessary before the Lo-Hi shift (Steps S610 and S620). Herein, as the Hi-Lo preprocessing, torque replacement processing and the like can be cited. In the torque replacement processing, the braking torque delivered from the motor MG2 and the braking force applied to the vehicle by motoring the engine 22 by the motor MG1 are replaced with a brake torque applied to the drive wheels 39a and 39b and the driven wheels by the brake wheel cylinders 96a to 96d. When the Hi-Lo preprocessing is unnecessary, or after the Hi-Lo preprocessing has been performed, the target rotation speed Nm2tg, which is the rotation speed of the motor MG2 at the time when the state of the transmission 60 is changed from the Hi gear state to the Lo gear state, is calculated by Equation (11) using the present rotation speed Nm2 of the motor MG2, the change gear ratio Glo at the time when the transmission 60 is in the Lo gear state, and the change gear ratio Ghi at the time when the transmission 60 is in the Hi gear ratio (Step S630), and to turn the brake B1 of the transmission 60 off and to turn the brake B2 thereof on, the hydraulic sequence for the hydraulically driven actuator, not shown, of the transmission 60 is started (Step S640). One example of the hydraulic sequence at the time when the state of the transmission 60 is changed from the Hi gear state to the Lo gear state is shown in FIG. 15. In FIG. 15, a large hydraulic command of the brake B2 immediately after the start of sequence is due to a first fill for filling oil in the cylinder before an engagement force is applied to the brake B2. After the control rotation speed Nm2* of the motor MG2 has synchronized with the rotation speed after shift (target rotation speed) Nm2tg (Steps S650 and S660), the brake B2 is completely turned on to finish the hydraulic sequence (Step S670), and also when the Hi-Lo preprocessing has been performed, Hi-Lo return processing, which is a return processing reverse to the Hi-Lo preprocessing, is performed (Steps S690 and S700) to finish the shift processing. Even in the control of Hi-Lo shift as described above, control can be carried out more appropriately by using the control rotation speed Nm2* as the rotation speed of the motor MG2. For the Hi-Lo shift, after the hydraulic sequence has been started, for the motor MG2, in some cases, the rotation speed control is carried out so that the control rotation speed Nm2* thereof becomes the rotation speed after shift (target rotation speed) Nm2tg. However, the illustration and explanation of this processing are omitted.

Nm2tg=Nm2·Glo/Ghi (11)

According to the hybrid vehicle 20 of the embodiment described above, when the shift stage of the transmission 60 is being changed, the rotation speed predicted at the control time by using the value obtained by multiplying the time differential component of the rotation speed Nm2 of the motor MG2 by the gain km is set as the control rotation speed Nm2*, and also the change gear ratio Gr of the transmission 60 is calculated by using this control rotation speed Nm2*. By using the control rotation speed Nm2* and the change gear ratio Gr, the torque command Tm1* of the motor MG1 and the torque command Tm2* of the motor MG2 are set so that the engine 22 is operated at the operation point represented by the target rotation speed Ne* and the target torque Te* within the range of the input limit Win to the output limit Wout of the battery 50, by which the engine 22 and the motors MG1 and MG2 are controlled. That is to say, the rotation speed predicted at the control time is controlled by the control rotation speed Nm2* and the change gear ratio Gr of the transmission 60 calculated by using the control rotation speed Nm2*. Therefore, even in the case where deviation of the actual rotation speed from the rotation speed of the motor MG2 is induced by sensing delay, calculation delay, or communication delay, the motor MG1 and the motor MG2 can be controlled more appropriately. As a result, unexpected fluctuations in torque of the ring gear shaft 32a serving as a drive shaft, which may be produced when the shift stage of the transmission 60 is changed while torque is delivered from the motor MG1, can be restricted. Needless to say, even when the shift stage of the transmission 60 is being changed, the vehicle can be run while the torque demand Tr* is delivered to the ring gear shaft 32a serving as a drive shaft within the range of the input limit Win to the output limit Wout of the battery 50. Also, when the shift stage of the transmission 60 is not being changed, the inputted rotation speed Nm2 of the motor MG2 is set as the control rotation speed Nm2* as it is and also the change gear ratio Gr of the transmission 60 is calculated by using this control rotation speed Nm2*, and by using the control rotation speed Nm2* and the change gear ratio Gr, the torque command Tm1* of the motor MG1 and the torque command Tm2* of the motor MG2 are set so that the engine 22 is operated at the operation point represented by the target rotation speed Ne* and the target torque Te* within the range of the input limit Win to the output limit Wout of the battery 50, by which the engine 22 and the motors MG1 and MG2 are controlled. Therefore, the vehicle can be run while the torque demand Tr* is delivered stably to the ring gear shaft 32a serving as a drive shaft within the range of the input limit Win to the output limit Wout of the battery 50.

In the hybrid vehicle 20 of this embodiment, the rotation speed that is obtained by adding a value obtained by multiplying the difference ΔNm2, which corresponds to the time differential component of the rotation speed Nm2 of the motor MG2, by a gain km to the rotation speed Nm2 is set as the control rotation speed Nm2*, which is the rotation speed predicted at the control time. However, besides the above-described method, other methods may be used as the calculating method for the rotation speed predicted at the control time to set the control rotation speed Nm2*.

In the hybrid vehicle 20 of this embodiment, the transmission 60 capable of changing the speed with two shift stages of Hi and Lo is used. However, the number of shift stages of the transmission 60 is not limited to two, and three or more shift stages may be used.

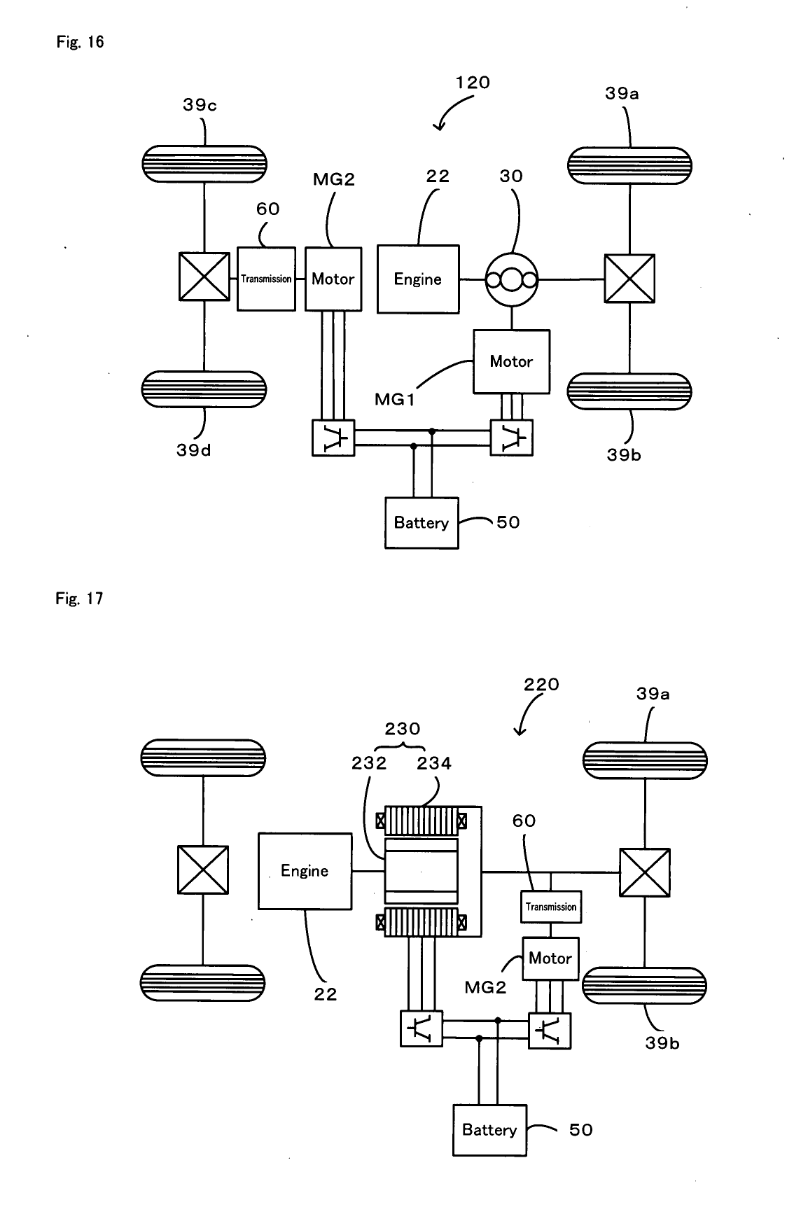

In the hybrid vehicle 20 of this embodiment, the power of the motor MG2 is delivered to the ring gear shaft 32a by accomplishing gear shift by using the transmission 60. However, as typically shown in a hybrid vehicle 120 of a modified example shown in FIG. 16, the power of the motor MG2 is speed-changed by the transmission 60 and may be connected to an axle (the axle to which wheels 39c and 39d are connected in FIG. 16) different from the axle to which the ring gear shaft 32a is connected (the axle to which the drive wheels 39a and 39b are connected).

In the hybrid vehicle 20 of the embodiment, the power of the engine 22 is output via the power distribution integration mechanism 30 to the ring gear shaft 32a functioning as the drive shaft linked with the drive wheels 39a and 39b. In another possible modification of FIG. 17, a hybrid vehicle 220 may have a pair-rotor motor 230, which has an inner rotor 232 connected with the crankshaft 26 of the engine 22 and an outer rotor 234 connected with the drive shaft for outputting the power to the drive wheels 39a, 39b and transmits part of the power output from the engine 22 to the drive shaft while converting the residual part of the power into electric power.

The present invention is not limited to the power output apparatus applied to the hybrid vehicle as described above. The present invention may be applied to a power output apparatus mounted on a mobile object such as a vehicle other than the automobile, ship, airplane, and the like, and may be applied to a power output apparatus incorporated in an immobile facility such as a construction facility. Also, the present invention may be applied to a drive system incorporated in the above-described power output apparatus together with an engine and a battery. Further, the present invention may be applied to a method for controlling the above-described power output apparatus.

Herein, an explanation is given of the corresponding relationship between the principal elements of the embodiment and the principal elements of the invention described in the section of Summary. In the embodiment, the engine 22 corresponds to an “internal combustion engine”, the power distribution and integration mechanism 30 and the motor MG1 correspond to an “electric power-mechanical power input output mechanism”, the motor MG2 corresponds to a “motor”, the transmission 60 corresponds to a “transmission mechanism”, the battery 50 corresponds to an “accumulator unit”, and the rotation speed sensor 32b corresponds to a “drive shaft rotation speed detecting mechanism”. The rotation position detection sensor 44 and the motor ECU 40 that calculates the rotation speed Nm2 of the motor MG2 based on the signal sent from the rotation position detection sensor 44 correspond to a “motor rotation speed detecting mechanism”. The hybrid electronic control unit 70 that executes the processing in Step S150 of the drive control routine shown in FIG. 6, in which the rotation speed that is obtained by adding a value obtained by multiplying the difference ΔNm2, which corresponds to the time differential component of the rotation speed Nm2 of the motor MG2, by the gain km to the rotation speed Nm2 is set as the control rotation speed Nm2*, which is the rotation speed predicted at the control time, corresponds to a “predicted rotation speed calculating mechanism”. The hybrid electronic control unit 70 that executes the processing in Step S110 of the drive control routine shown in FIG. 6, in which the torque demand Tr* based on the accelerator opening Acc and the vehicle speed V corresponds to a “torque demand setting mechanism”. The hybrid electronic control unit 70 that executes the processing in Steps S130 to S160 of the drive control routine shown in FIG. 6, in which when the shift stage of the transmission 60 is being changed, the rotation speed predicted at the control time is set as the control rotation speed Nm2* by using the value obtained by multiplying the time differential component of the rotation speed Nm2 of the motor MG2 by the gain km and also the change gear ratio Gr of the transmission 60 is calculated by using this control rotation speed Nm2*, and when the shift stage of the transmission 60 is not being changed, the inputted rotation speed Nm2 of the motor MG2 is set as the control rotation speed Nm2* as it is and also the change gear ratio Gr of the transmission 60 is calculated by using this control rotation speed Nm2*, corresponds to a “control change gear ratio calculating mechanism”. The hybrid electronic control unit 70 that executes the processing in Steps S170 to S230 of the drive control routine shown in FIG. 6, in which by using the set control rotation speed Nm2* and the change gear ratio Gr, the torque command Tm1* of the motor MG1 and the torque command Tm2* of the motor MG2 are set so that the engine 22 is operated at the operation point represented by the target rotation speed Ne* and the target torque Te* within the range of the input limit Win to the output limit Wout of the battery 50 to send the set value to the engine ECU 24 and the motor ECU 40, and controls the change of shift stage of the transmission 60 by means of the shift control routine shown in FIG. 12, and the engine ECU 24 for controlling the engine 22 based on the target rotation speed Ne* and the target torque Te*, and the motor ECU 40 for controlling the motors MG1 and MG2 based on the torque commands Tm1* and Tm2* correspond to a “control module”. Also, the battery ECU 52 that calculates the input and output limits Win and Wout, which are maximum allowable power that allows the charge and discharge of the battery 50, based on the state of charge (SOC) of the battery 50 calculated based on the integrated value of the charge-discharge current detected by the current sensor and the battery temperature Tb of the battery 50 corresponds to an “input and output limits setting mechanism”. The motor MG1 corresponds to a “generator”, and the power distribution and integration mechanism 30 corresponds to a “three shaft-type power input output module”. Also, a pair-rotor motor 230 also corresponds to an “electric power-mechanical power input output mechanism”.

The “internal combustion engine” is not limited to an internal combustion engine that delivers power by means of a hydrocarbon-based fuel such as gasoline or light oil, and any type of internal combustion engine such as a hydrogen-fueled engine may be used. The “electric power-mechanical power input output mechanism” is not limited to the combination of the power distribution and integration mechanism 30 and the motor MG1 or the pair-rotor motor 230, and any type of mechanism that is connected to the drive shaft and also connected to the output shaft of the internal combustion engine capable of being rotated independently of the drive shaft, and inputs and outputs torque to and from the drive shaft and the output shaft along with the input and output of electric power and mechanical power may be used. The “motor” is not limited to the motor MG2 configured as a synchronous motor generator, and any type of motor that can input and output electric power, such as an induction motor, may be used. The “transmission mechanism” is not limited to the transmission 60 capable of changing the speed with two shift stages of Hi and Lo, and any type of transmission that transmits power by means of gear shift along with the change of change gear ratio between the rotating shaft of motor and the drive shaft, such as a transmission that changes the speed rang with three or more shift stages or a non-stage transmission that changes the speed range in a stepless manner, may be used. The “accumulator unit” is not limited to the battery 50, which is a secondary battery, and any type of unit that gives and gets electric power to and from the electric power-mechanical power input output mechanism and the motor, such as a capacitor, may be used. The “drive shaft rotation speed detecting mechanism” is not limited to the rotation speed sensor 32b, and any type of mechanism that detects the drive shaft rotation speed, which is the rotation speed of drive shaft, such as a mechanism that detects the rotation speed of the ring gear shaft 32a by multiplying the value obtained from a sensor for detecting the vehicle speed by a conversion factor, may be used. The “motor rotation speed detecting mechanism” is not limited to the mechanism that calculates the rotation speed Nm2 of the motor MG2 based on the signal sent from the rotation position detection sensor 44, and any type of mechanism that detects the motor rotation speed, which is the rotation speed of motor, may be used. The “predicted rotation speed calculating mechanism” is not limited to the mechanism that sets the rotation speed obtained by adding the value obtained by multiplying the difference ΔNm2, which corresponds to the time differential component of the rotation speed Nm2 of the motor MG2, by the gain km to the rotation speed Nm2 as the control rotation speed Nm2*, which is the predicted rotation speed at the control time, and any type of mechanism that calculates the predicted rotation speed of motor, which is the rotation speed of motor predicted at the control time, based on the motor rotation speed may be used. The “torque demand setting mechanism” is not limited to the mechanism that sets the torque demand Tr* based on the accelerator opening Acc and the vehicle speed V, and any type of mechanism that sets the torque demand required by the drive shaft, such as a mechanism that sets the torque demand based on the accelerator opening Acc only or a mechanism that sets the torque demand based on a running position on the running path in the case where the running path is set in advance, may be used. The “control change gear ratio calculating mechanism” is not limited to the mechanism that sets the rotation speed predicted at the control time as the control rotation speed Nm2* by using the value obtained by multiplying the time differential component of the rotation speed Nm2 of the motor MG2 by the gain km and also calculates the change gear ratio Gr of the transmission 60 by using this control rotation speed Nm2* when the shift stage of the transmission 60 is being changed, and sets the inputted rotation speed Nm2 of the motor MG2 as the control rotation speed Nm2* as it is and also calculates the change gear ratio Gr of the transmission 60 by using this control rotation speed Nm2* when the shift stage of the transmission 60 is not being changed, and any type of mechanism that calculates the control change gear ratio, which is the change gear ratio for controlling the transmission mechanism, based on the drive shaft rotation speed and the motor rotation speed when the change gear ratio of the transmission 60 is not being changed, and calculates the control change gear ratio based on the drive shaft rotation speed and the predicted rotation speed when the change gear ratio of the transmission 60 is being changed may be used. The “control module” is not limited to the combination of the hybrid electronic control unit 70, the engine ECU 24, and the motor ECU 40, and the control module may be configured by a single electronic control unit. Also, the “control module” is not limited to the module that controls the shift of the transmission 60 and also sets, by using the set control rotation speed Nm2* and the change gear ratio Gr, the torque command Tm1* of the motor MG1 and the torque command Tm2* of the motor MG2 so that the engine 22 is operated at the operation point represented by the target rotation speed Ne* and the target torque Te* within the range of the input limit Win to the output limit Wout of the battery 50 to control the engine 22 and the motors MG1 and MG2, and any type of module that controls the internal combustion engine, the electric power-mechanical power input output mechanism, the motor, and the transmission mechanism by using the control change gear ratio calculated along with the change of the change gear ratio of the transmission mechanism so that the torque based on the torque demand is delivered to the drive shaft may be used. The “input and output limits setting mechanism” is not limited to the mechanism that calculates the input and output limits Win and Wout based on the state of charge (SOC) of the battery 50 and the battery temperature Tb of the battery 50, and any type of mechanism that sets the input and output limits, which are maximum allowable power that allows the charge and discharge of the accumulator unit, based on the state of accumulator unit, such as a mechanism that performs the calculation based on the internal resistance or the like of the battery 50 besides the state of charge (SOC) and the battery temperature Tb, may be used. The “generator” is not limited to the motor MG1 configured as a synchronous motor generator, and any type of motor that can input and output electric power, such as an induction motor, may be used. The “three shaft-type power input output module” is not limited to the aforementioned power distribution and integration mechanism 30, and any type of module that is connected to the three shafts of the drive shaft, the output shaft, and the rotating shaft of generator and inputs and outputs power, based on the power inputted to and outputted from any two shafts of the three shafts, to and from the remaining shaft, such as a module using a double pinion-type planetary gear mechanism, a module that is connected to four or more shafts by combining a plurality of planetary gear mechanisms, or a module having working operation different from the planetary gear like a differential gear, may be used.

The corresponding relationship between the principal elements of the embodiment and the principal elements of the invention described in the section of Summary is one example for specifically explaining the best mode for the embodiment to carry out the invention described in the section of Summary, and therefore does not restrict the elements of the invention described in the section of Summary. That is to say, the invention described in the section of Summary should be interpreted based on the description in that section. The embodiment is merely one specific example of the invention described in the section of Summary.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

The disclose of Japanese Patent Application No. 2007-92305 filed Mar. 30, 2007 including specification, drawings and claims is incorporated herein by reference in its entirety.

What is claimed is:

1. A power output apparatus for delivering power to a drive shaft, the power output apparatus comprising:
an internal combustion engine;
an electric power-mechanical power input output mechanism which is connected to the drive shaft and also rotatably connected to an output shaft of the internal combustion engine independently of the drive shaft to input and output torque to and from the drive shaft and the output shaft along with the input and output of electric power and mechanical power;
a motor capable of delivering mechanical power;
a transmission mechanism which is connected to a rotating shaft of the motor and the drive shaft to accomplish gear shift of mechanical power along with the change of change gear ratio between the rotating shaft and the drive shaft;
an accumulator unit capable of sending electric power to and from the electric power-mechanical power input output mechanism and the motor;
a drive shaft rotation speed detecting mechanism for detecting a drive shaft rotation speed, which is the rotation speed of the drive shaft;
a motor rotation speed detecting mechanism for detecting a motor rotation speed, which is the rotation speed of the motor;
a predicted rotation speed calculating mechanism for calculating a predicted rotation speed, which is the rotation speed of the motor predicted at the control time, based on the detected motor rotation speed;
a torque demand setting mechanism for setting a torque demand required by the drive shaft;
a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and
a control module which controls the internal combustion engine, the electric power-mechanical power input output mechanism, the motor, and the transmission mechanism so that the torque based on the set torque demand is delivered to the drive shaft by using the calculated control change gear ratio along with the change of the change gear ratio of the transmission mechanism.

2. A power output apparatus according to claim 1, wherein
for the motor, the control module is a module for controlling the motor so that the torque obtained based on a necessary torque obtained by subtracting a direct torque, which is delivered to the drive shaft via the electric power-mechanical power input output mechanism, from the set torque demand and the calculated control change gear ratio is delivered from the motor.

3. A power output apparatus according to claim 2, wherein
the power output apparatus further comprises an input and output limits setting mechanism for setting input and output limits, which are maximum allowable power that allows the charge and discharge of the accumulator unit, based on the state of accumulator unit, and
for the motor, the control module is a module for controlling the motor so that the torque obtained by dividing the necessary torque by the control change gear ratio within the range of an input limit to an output limit is delivered from the motor.

4. A power output apparatus according to claim 1, wherein
for the internal combustion engine and the electric power-mechanical power input output mechanism, the control module is a module for controlling the internal combustion engine and the electric power-mechanical power input output mechanism so that a target operation point at which the internal combustion engine should be operated is set based on the set torque demand and a predetermined restriction on the operation of the internal combustion engine and a target drive state of the electric power-mechanical power input output mechanism is set so that the internal combustion engine is operated at the set target operation point, and the internal combustion engine is operated at the set target operation point and also the electric power-mechanical power input output mechanism is driven in the set target drive state.

5. A power output apparatus according to claim 1, wherein
the predicted rotation speed calculating mechanism is a mechanism for calculating the predicted rotation speed by adding a corrected rotation speed obtained by multiplying a value corresponding to the time differential component of the detected motor rotation speed by a predetermined gain to the detected motor rotation speed.

6. A power output apparatus according to claim 1, wherein
the transmission mechanism is a stepped transmission.

7. A power output apparatus according to claim 1, wherein
the electric power-mechanical power input output mechanism is a mechanism having a generator for inputting and outputting power and a three shaft-type power input output module that is connected to the drive shaft, the output shaft, and the rotating shaft of the generator, and inputs and outputs power, based on the power inputted to and outputted from any two shafts of the three shafts, to and from the remaining shaft.

8. A vehicle comprising:
an internal combustion engine;
an electric power-mechanical power input output mechanism which is connected to a drive shaft connected to an axle and also rotatably connected to an output shaft of the internal combustion engine independently of the drive shaft to input and output torque to and from the drive shaft and the output shaft along with the input and output of electric power and mechanical power;
a motor capable of delivering mechanical power;
a transmission mechanism which is connected to a rotating shaft of the motor and the drive shaft to accomplish gear shift of mechanical power along with the change of change gear ratio between the rotating shaft and the drive shaft;
an accumulator unit capable of sending electric power to and from the electric power-mechanical power input output mechanism and the motor;
a drive shaft rotation speed detecting mechanism for detecting a drive shaft rotation speed, which is the rotation speed of the drive shaft;
a motor rotation speed detecting mechanism for detecting a motor rotation speed, which is the rotation speed of the motor;
a predicted rotation speed calculating mechanism for calculating a predicted rotation speed, which is the rotation speed of the motor predicted at the control time, based on the detected motor rotation speed;
a torque demand setting mechanism for setting a torque demand required by the drive shaft;
a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and
a control module which controls the internal combustion engine, the electric power-mechanical power input output mechanism, the motor, and the transmission mechanism so that the torque based on the set torque demand is delivered to the drive shaft by using the calculated control change gear ratio along with the change of the change gear ratio of the transmission mechanism.

9. A drive system incorporated in a power output apparatus for delivering power to a drive shaft together with an internal combustion engine and an accumulator unit, the drive system comprising:
an electric power-mechanical power input output mechanism which can send and receive electric power to and from the accumulator unit, and is connected to the drive shaft and also rotatably connected to an output shaft of the internal combustion engine independently of the drive shaft to input and output torque to and from the drive shaft and the output shaft along with the input and output of electric power and mechanical power;
a motor which can send and receive electric power to and from the accumulator unit and can deliver mechanical power;
a transmission mechanism which is connected to a rotating shaft of the motor and the drive shaft to accomplish gear shift of mechanical power along with the change of change gear ratio between the rotating shaft and the drive shaft;
a drive shaft rotation speed detecting mechanism for detecting a drive shaft rotation speed, which is the rotation speed of the drive shaft;
a motor rotation speed detecting mechanism for detecting a motor rotation speed, which is the rotation speed of the motor;
a predicted rotation speed calculating mechanism for calculating a predicted rotation speed, which is the rotation speed of the motor predicted at the control time, based on the detected motor rotation speed;
a torque demand setting mechanism for setting a torque demand required by the drive shaft;
a control change gear ratio calculating mechanism which calculates a control change gear ratio, which is the control change gear ratio of the transmission mechanism, based on the detected drive shaft rotation speed and the detected motor rotation speed when the change gear ratio of the transmission mechanism is not being changed, and calculates the control change gear ratio based on the detected drive shaft rotation speed and the calculated predicted rotation speed when the change gear ratio of the transmission mechanism is being changed; and
a control module which controls the electric power-mechanical power input output mechanism, the motor, and the transmission mechanism in addition to the internal combustion engine so that the torque based on the set torque demand is delivered to the drive shaft by using the calculated control change gear ratio along with the change of the change gear ratio of the transmission mechanism.

10. A method for controlling a power output apparatus having an internal combustion engine; an electric power-mechanical power input output mechanism which is connected to a drive shaft and also rotatably connected to an output shaft of the internal combustion engine independently of the drive shaft to input and output torque to and from the drive shaft and the output shaft along with the input and output of electric power and mechanical power; a motor capable of delivering mechanical power; a transmission mechanism which is connected to a rotating shaft of the motor and the drive shaft to accomplish gear shift of mechanical power along with the change of change gear ratio between the rotating shaft and the drive shaft; and an accumulator unit capable of sending electric power to and from the electric power-mechanical power input output mechanism and the motor, the method comprising the steps of:
(a) calculating a predicted rotation speed, which is the rotation speed of the motor predicted at the control time, based on a motor rotation speed, which is the rotation speed of the motor;
(b) calculating a control change gear ratio, which is the control change gear ratio of the transmission mechanism, based on a drive shaft rotation speed, which is the rotation speed of the drive shaft, and the motor rotation speed when the change gear ratio of the transmission mechanism is not being changed, and calculating the control change gear ratio based on the drive shaft rotation speed and the predicted rotation speed when the change gear ratio of the transmission mechanism is being changed; and
(c) controlling the internal combustion engine, the electric power-mechanical power input output mechanism, the motor, and the transmission mechanism so that the torque based on a torque demand required by the drive shaft is delivered to the drive shaft by using the control change gear ratio along with the change of the change gear ratio of the transmission mechanism.
